(19) United States
(12) Patent Application Publication
(10) Pub. No.: US 2012/0106126 A1
(43) Pub. Date: May 3, 2012

(54) WAVELENGTH CONVERSION ELEMENT, LIGHT SOURCE DEVICE, AND PROJECTOR

(75) Inventors: Shigeo NOJIMA, Suwa-shi (JP); Tsuyoshi KANEKO, Shimosuwa-machi (JP); Daisuke SAWAKI, Shiojiri-shi (JP)

(73) Assignee: SEIKO EPSON CORPORATION, Tokyo (JP)

(21) Appl. No.: 13/280,710

(22) Filed: Oct. 25, 2011

(30) Foreign Application Priority Data
Nov. 1, 2010 (JP) 2010-245025
Nov. 1, 2010 (JP) 2010-245032
Sep. 9, 2011 (JP) 2011-196888

(51) Int. Cl. F21V 9/16; F21V 29/00; F21V 7/00

(52) U.S. Cl. 362/84; 362/296.01; 362/297; 362/294

(57) ABSTRACT

The phosphor wheel (wavelength conversion element) includes: a substrate; a light-emitting element having at least a phosphor layer provided on one surface of the substrate; and a first reflective portion provided in at least a first side face of the phosphor layer to change a propagation direction of the light propagating inside the phosphor layer such that an angle with respect to a normal line of the emission face where the fluorescent light is emitted from the light-emitting element is reduced.

### BACKGROUND

1. Technical Field

The present invention relates to a wavelength conversion element, a light source device, and a projector, and more particularly, to a phosphor wheel for generating fluorescent light that can be preferably used in the wavelength conversion element, the light source device, and the projector.

2. Related Art

As one of light source devices used in the projectors, there has been proposed a light source device that generates a fluorescent light having a wavelength different from that of an excitation light by irradiating laser light as the excitation light to a phosphor (for example, JP-A-2009-277516 and JP-A-2010-86815).

In the related art, the phosphor layer of the phosphor wheel serving as a wavelength conversion element is provided in an area which is larger than the spot of the excitation light formed on the phosphor wheel. A plurality of phosphor particles (phosphor crystals) distributed in the phosphor layer isotropically radiates the generated fluorescent light. Since the phosphor layer has a predetermined thickness, the fluorescent component inclined with a large angle with respect to the normal line of the plane of the wheel substrate propagates through the phosphor layer up to the outer side of the spot of the excitation light. The fluorescent light propagating to the outer side of the spot of the excitation light is further scattered by phosphor particles located in front. As the fluorescent light propagates outside the spot by repeating the scattering in the phosphor layer, the light-emitting area in the phosphor wheel increases, that is, the etendue increases. As the light-emitting area in the phosphor wheel increases, the amount of light that cannot be collected by the optical systems located in rear of the light source device increases. Therefore, the optical use efficiency over the entire system including the phosphor wheel is degraded.

The light emitted from the phosphor layer has an angular distribution approximate to that of the Lambert radiation. The light emitted from the phosphor layer with a large angle with respect to the normal line of the emission face of the phosphor layer is difficult to be sufficiently captured by a waveguide unit or a pickup lens provided to the emission side of the phosphor layer. Therefore, the optical use efficiency is degraded.

### SUMMARY

An advantage of some aspects of the invention is to provide a wavelength conversion element, a light source device, and a projector capable of improving the optical use efficiency over the entire system which includes the wavelength conversion element.

An aspect of the invention is directed to a wavelength conversion element including: a substrate; a light-emitting element having at least a phosphor layer provided in one surface of the substrate; and a first reflective portion provided in at least a first side face of the phosphor layer to change a propagation direction of the a light propagating inside the phosphor layer such that an angle with respect to a normal line of an emission face through which a fluorescent light is emitted from the light-emitting element is reduced.

In this configuration, the first reflective portion reflects the light propagating inside the phosphor layer in parallel with the one surface of the substrate. As a result, the first reflective portion restricts the light-emitting area of the phosphor layer and suppresses the light-emitting area from increasing. That is, the light-emitting area does not exceed the first reflective portion.

Furthermore, the first reflective portion changes the propagation direction of the light propagating inside the phosphor layer such that an angle with respect to a normal line of the emission face through which the fluorescent light from the light-emitting element is emitted is reduced. Namely, the propagation direction of the light may be changed such that a beam angle with respect to the normal line of the emission face of the light-emitting element is reduced. Here, an interface between the light-emitting element and the air corresponds to the emission face of the light-emitting element. As such, since the beam angle on the emission face of the light-emitting element is reduced, a total reflection of the light on the emission face of the light-emitting element is suppressed. In addition, since the emission angle of the light emitted from the light-emitting element is reduced, the amount of light which can be collected by the pickup lens or by the optical guide unit increases. As a result, it is possible to suppress degradation of the optical use efficiency over the entire system which includes the wavelength conversion element.

In the wavelength conversion element described above, it is preferable that the substrate be rotatable around a rotation axis intersecting with the one surface of the substrate.

In this configuration, since the substrate is rotatable, a spot of the excitation light formed on the wavelength conversion element when the excitation light is irradiated onto the substrate is moved temporally, and the time for irradiating the excitation light per unit area is shortened. As a result, an increase in the temperature of the phosphor layer, which may be caused by irradiating the excitation light onto the phosphor layer, can be suppressed. Consequently, degradation of the wavelength conversion efficiency, which may be caused by a high temperature of the phosphor layer, can be suppressed.

In the wavelength conversion element described above, it is preferable that the first side face be parallel to any one of a direction along a circle centered at the rotation axis and a direction intersecting with the circle.

In a case where the first side face is parallel to the direction along the circle centered at the rotation axis of the substrate, it is possible to suppress the light-emitting area from increasing in a radial direction of the circle and to reduce the beam angle of the light emitted from the light-emitting element. In a case where the first side face is parallel to a direction intersecting with the circle centered at the rotation axis of the substrate, it is possible to suppress the light-emitting area from increasing in a circumferential direction of the circle and to reduce the beam angle of the light emitted from the light-emitting element.

It is preferable that the wavelength conversion element described above further includes a second reflective portion provided in a second side face of the phosphor layer opposite to the first side face to change the propagation direction of the light propagating inside the phosphor layer such that an angle with respect to a normal line of the emission face is reduced.

As a result, it is possible to further suppress the light-emitting area from increasing. In addition, since it is possible to increase the amount of light emitted from the light-emitting element with a small beam angle, it is possible to further increase the amount of light which can be collected by the pickup lens or the optical guide unit.

It is preferable that the wavelength conversion element described above further includes: a third reflective portion provided in a third side face of the phosphor layer intersecting with the first side face to change a propagating direction of a light propagating inside the phosphor layer such that an angle with respect to the normal line of the emission face is reduced; and a fourth reflective portion provided in a fourth side face of the phosphor layer opposite to the third side face to change a propagating direction of the light propagating inside the phosphor layer such that an angle with respect to a normal line of the emission face is reduced.

As a result, in a case where the excitation light is irradiated onto the phosphor layer while the wavelength conversion element is rotated around a predetermined rotation axis, it is possible to restrict the light-emitting area in both the radial direction and the circumferential direction of the circle centered at the rotation axis. Therefore, it is possible to further suppress the light-emitting area from increasing. In addition, it is possible to further increase the amount of light which can be collected by the pickup lens or the optical guide unit.

In the wavelength conversion element described above, it is preferable that the light-emitting element further includes a light-transmitting layer provided in a side of the phosphor layer opposite to the substrate.

In this configuration, since the light-transmitting layer is provided in a side of the phosphor layer opposite to the substrate, the amount of light emitted from the phosphor layer to an outside of the substrate increases in comparison with a case where the light-transmitting layer is not provided. This is because the critical angle at the interface between the phosphor layer and the light-transmitting layer is larger than the critical angle at the interface between the phosphor layer and the air.

In the wavelength conversion element described above, it is preferable that the phosphor layer has a binder in which a plurality of phosphor particles is distributed, and a refractive index of the light-transmitting layer be equal to a refractive index of the binder.

In this configuration, the fluorescent light emitted from the phosphor is not reflected at the interface between the phosphor layer and the light-transmitting layer and is not returned to the phosphor layer. For this reason, it is possible to suppress optical losses or generation of heat which may be caused by absorption of the fluorescent light in the phosphor layer.

In the wavelength conversion element described above, it is preferable that an embossed structure be provided on a surface of the light-transmitting layer opposite to the phosphor layer.

In this configuration, due to the embossed structure, it is possible to suppress reflection of light at the interface between the light-transmitting layer and the air. Consequently, it is possible to efficiently extract the light from the light-transmitting layer.

In the wavelength conversion element described above, it is preferable that the phosphor layer be provided on a surface of the substrate.

Since the phosphor layer is provided on a surface of the substrate, it is possible to effectively externally radiate the heat generated in the phosphor layer.

In the wavelength conversion element described above, it is preferable that the phosphor layer be provided in a trench provided in the substrate.

Since the phosphor layer is provided in the trench of the substrate, it is possible to stably coat a material of the phosphor layer.

It is preferable that the wavelength conversion element described above further includes a heat conduction member provided in a side of the first reflective portion opposite to the phosphor layer.

As a result, it is possible to effectively radiate the heat generated in the phosphor layer.

In the wavelength conversion element described above, it is preferable that the substrate be made of metal.

As a result, it is possible to effectively radiate the heat generated in the phosphor layer.

It is preferable that the wavelength conversion element described above further includes a wavelength splitting layer provided between the substrate and the phosphor layer to transmit excitation light for exciting the phosphor and to reflect fluorescent light emitted from the phosphor.

The wavelength splitting layer reflects the fluorescent light propagating inside the phosphor layer to an incident face where the excitation light enters. As a result, the wavelength conversion element can efficiently emit the fluorescent light when the excitation light is irradiated from the side opposite to the side where the phosphor layer of the substrate is provided.

It is preferable that the wavelength conversion element described above further includes a reflective layer provided between the substrate and the phosphor layer to reflect excitation light for exciting the phosphor and fluorescent light emitted from the phosphor.

As a result, the wavelength conversion element can efficiently emit a part of the excitation light and the fluorescent light when the excitation light is irradiated to the phosphor from the side opposite to the substrate.

Another aspect of the invention is directed to a light source device including: an excitation light source unit for emitting an excitation light; and a wavelength conversion element for emitting a fluorescent light by being irradiated with the excitation light as described above.

As a result, it is possible to provide a light source device having a high optical use efficiency over the entire system which includes the light source device, and the light source device is capable of obtaining desired color light.

In the light source device described above, it is preferable that, in a radial direction of a circle centered at a rotation axis intersecting with the one surface of the substrate, the size of the spot of the excitation light formed in the wavelength conversion element is substantially equal to or smaller than a width of the incident face of the light-emitting element where the excitation light enters.

As a result, the incident position of the excitation light, that is, the spot of the excitation light formed in the wavelength conversion element does not exceed the incident face of the light-emitting element where the excitation light enters. Therefore, it is possible to increase the allowable range of the wobbling caused by rotation of the wavelength conversion element.

It is preferable that the light source device described above further includes: a drive unit for driving the wavelength conversion element such that the spot is shifted temporally on the wavelength conversion element; and a correction unit for correcting at least one of a relative positional relationship between the phosphor layer and the spot and the size of the spot when the drive unit drives the wavelength conversion element.

If the wavelength conversion element is driven by the drive unit such that the spot of the excitation light is moved temporally on the wavelength conversion element, it is possible to suppress the temperature of the phosphor layer from increasing and to suppress degradation of the wavelength conversion efficiency which may be caused when the temperature of the phosphor layer increases. However, if a positional deviation of the phosphor layer occurs when the drive unit drives the wavelength conversion element, the amount of the excitation light incident on the phosphor layer is fluctuated temporally, and the amount of light emitted from the phosphor layer is also fluctuated temporally. In this regard, according to the configuration described above, since the correction unit for correcting the positional deviation of the phosphor layer is provided, it is possible to reduce the temporal fluctuation of the amount of light emitted from the phosphor layer. In addition, since reduction of the excitation light incident on the phosphor layer is suppressed, it is possible to sufficiently obtain the amount of light emitted from the phosphor layer. In addition, it is possible to also suppress reduction of the use efficiency of the excitation light.

In the light source device described above, it is preferable that the wavelength conversion element be rotatable around a rotation axis intersecting with the one surface of the substrate, and the phosphor layer be provided along a circle centered at the rotation axis on one surface of the substrate.

In this configuration, since the substrate is rotatable, the spot of the excitation light is moved temporally on the wavelength conversion element when the excitation light is irradiated onto the phosphor layer. For this reason, the time for irradiating the excitation light per unit area is shortened. As a result, it is possible to suppress the temperature of the phosphor layer from increasing when the excitation light is irradiated onto the phosphor layer and to suppress degradation of the wavelength conversion efficiency which may be caused when temperature of the phosphor layer increases.

In the light source device described above, it is preferable that the correction unit includes a first correction unit for correcting a positional deviation of the phosphor layer in a direction perpendicular to an optical axis direction of the excitation light.

In this configuration, the spot of the excitation light hardly gets out of the incident face of the light-emitting element on which the excitation light is incident. In other words, the spot of the excitation light is hardly misaligned with the incident face of the light-emitting element. Therefore, it is possible to efficiently use the excitation light. For this reason, it is possible to sufficiently obtain the amount of light emitted from the phosphor layer.

In the light source device described above, it is preferable that the correction unit includes a second correction unit for correcting the size of the spot by correcting a positional deviation of the phosphor layer in an optical axis direction of the excitation light.

In this configuration, the spot of the excitation light hardly externally exceeds the incident face of the light-emitting element on which the excitation light is incident. Therefore, it is possible to efficiently use the excitation light. For this reason, it is possible to sufficiently obtain the amount of light emitted from the phosphor layer.

It is preferable that the light source device described above further includes a detection unit for detecting an amount of a positional deviation of the phosphor layer, wherein the correction unit corrects the positional deviation based on a detection result of the detection unit.

In this configuration, since the detection unit for detecting the amount of the positional deviation of the phosphor layer is provided, it is possible to appropriately correct the positional deviation based on the detection result of the detection unit.

It is preferable that the light source device described above further includes a data storage unit for storing data representing an amount of a positional deviation of the phosphor layer, wherein the correction unit corrects the positional deviation based on the data stored in the data storage unit.

In this configuration, since the data storage unit for storing data representing the amount of the positional deviation of the phosphor layer is provided, it is possible to correct the deviation using a simple and easy configuration based on the data.

In the light source device described above, it is preferable that the substrate be rotatable around a rotation axis intersecting with the one surface of the substrate, the first side face intersect with a circle centered at the rotation axis, the wavelength conversion element further include a second reflective portion for reflecting a light propagating inside the phosphor layer in parallel with the substrate to a direction opposite to the substrate, the second reflective portion being provided in a second side face of the phosphor layer opposite to the first side face, and a pulse frequency F (Hz) be an integer multiple of a rotation number m (rps), where, F denotes a pulse frequency of the excitation light emitted from the excitation light source unit, and m denotes a rotation number of the wavelength conversion element.

In this configuration, the excitation light source unit can appropriately input the excitation light to the phosphor layer provided between the first and second reflective portions in a circumferential direction.

Still another aspect of the invention is directed to a projector for modulating the light emitted from the light source device described above in response to an image signal and projecting modulated light.

As a result, the projector can suppress degradation of the optical use efficiency of the entire system.

### BRIEF DESCRIPTION OF THE DRAWINGS

The invention will be described with reference to the accompanying drawings, wherein like numbers reference like elements.

FIG. 1 is a schematic configuration diagram illustrating a projector according to a first embodiment of the invention.

FIGS. 2A and 2B are diagrams illustrating configuration of a phosphor wheel.

FIG. 3 is a cross-sectional view illustrating the phosphor wheel.

FIG. 4 is a cross-sectional view illustrating main parts of a phosphor wheel according to a first modification of the first embodiment.

FIG. 5 is a cross-sectional view illustrating the main parts of the phosphor wheel according to a second modification of the first embodiment.

FIG. 6 is a schematic configuration diagram illustrating a projector according to a second embodiment of the invention.

FIG. 7 is a plan view illustrating a phosphor wheel.

FIG. 8 is a cross-sectional view illustrating the main parts of the phosphor wheel.

FIG. 9 is a cross-sectional view illustrating the main parts of the phosphor wheel.

FIG. 10 is a plan view illustrating a filter.

FIG. 11 is a cross-sectional view illustrating the main parts of the phosphor wheel according to a third embodiment of the invention.

FIG. 12 is a diagram illustrating an illumination device according to a third embodiment of the invention.

FIG. 13 is a schematic configuration diagram illustrating a projector according to a fourth embodiment of the invention.

FIG. 14 is a schematic configuration diagram illustrating a projector according to a fifth embodiment of the invention.

FIGS. 15A and 15B are schematic configuration diagrams illustrating configurations of a pickup lens and the phosphor wheel.

FIG. 16 is a cross-sectional view illustrating the main parts of the phosphor wheel.

FIG. 17 is a cross-sectional view illustrating the phosphor wheel according to a first modification of the fifth embodiment.

FIG. 18 is a plan view illustrating a phosphor wheel according to a second modification of the fifth embodiment.

FIG. 19 is a cross-sectional view illustrating the main parts of the phosphor wheel.

FIG. 20 is a cross-sectional view illustrating the main parts of the phosphor wheel according to a third modification of the fifth embodiment.

FIG. 21 is a cross-sectional view illustrating the main parts of the phosphor wheel according to a fourth modification of the fifth embodiment.

FIG. 22 is a plan view illustrating a phosphor wheel according to a sixth embodiment of the invention.

FIG. 23 is a perspective view illustrating a single unit structural body.

FIG. 24 is a cross-sectional view illustrating the main parts of the phosphor wheel in a circumferential direction.

FIG. 25 is a cross-sectional view illustrating the main parts of the phosphor wheel according to a seventh embodiment of the invention.

FIG. 26 is a diagram illustrating an exemplary light source device using the phosphor wheel.

FIG. 27 is a schematic configuration diagram illustrating a projector according to an eighth embodiment of the invention.

FIG. 28 is a schematic configuration diagram illustrating a projector according to a ninth embodiment of the invention.

FIG. 29 is a schematic configuration diagram illustrating a projector according to a tenth embodiment of the invention.

### DESCRIPTION OF EXEMPLARY EMBODIMENTS

Hereinafter, embodiments of the invention will be described in detail with reference to the accompanying drawings.

### First Embodiment

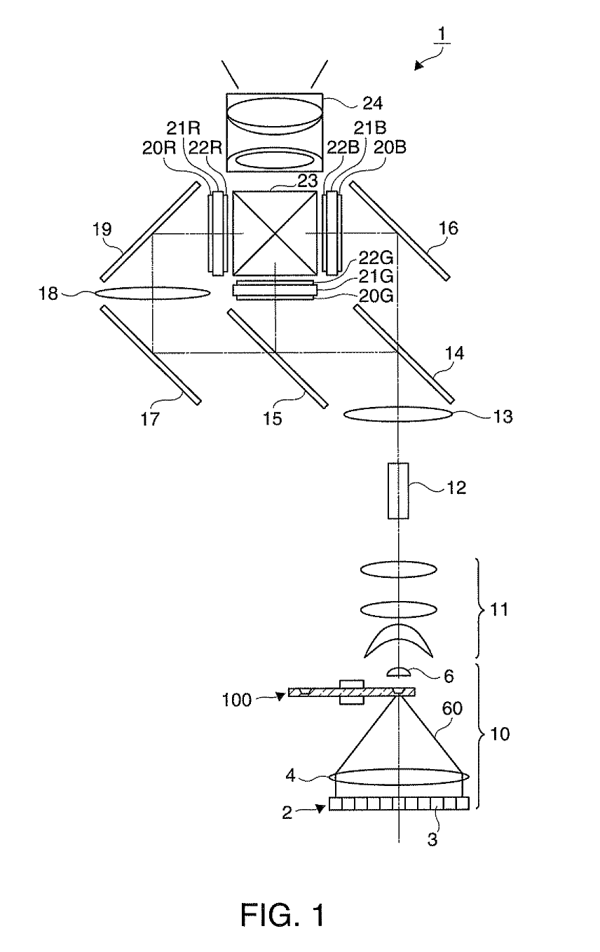

FIG. 1 is a schematic configuration diagram illustrating a projector 1 according to a first embodiment of the invention. A light source device 10 emits illumination light including red (R), green (G), and blue (B) light beams. The light source device 10 includes a laser diode array 2, a condensing lens 4, a phosphor wheel 100 serving as a wavelength conversion element, and a pickup lens 6.

The laser diode array 2 includes a plurality of laser diodes 3 arranged in an array shape. The laser diode array 2 serves as an excitation light source unit for emitting an excitation light 60. The excitation light 60 is, for example, blue light (B) having a wavelength of about 450 nm. The condensing lens 4 serves as a light condensing optical system for condensing the excitation light 60 emitted from the laser diode array 2 to the phosphor wheel 100.

The phosphor wheel 100 emits fluorescent light having a wavelength different from that of the excitation light 60 by being irradiated with the excitation light 60. The pickup lens 6 is provided in the optical path of the excitation light 60. The pickup lens 6 captures the fluorescent light emitted from the phosphor wheel 100 and excitation light 60 transmitting through the phosphor wheel 100, and then makes the fluorescent light and the excitation light propagate to a collimator optical system 11.

The collimator optical system 11 condenses the light from the light source device 10 onto a rod integrator 12. The rod integrator 12 internally multi-reflects the incident light to optically homogenize the light, and emits the homogenized light to a superposition lens 13. The superposition lens 13 superposes a plurality of light beams divided by the rod integrator 12 onto a spatial optical modulation device.

A first dichroic mirror 14 reflects the red light (R) and the green light (G) incident from the superposition lens 13 and transmits the blue light (B). The blue light (B) transmitting through the first dichroic mirror 14 is reflected by a reflection mirror 16 to bend an optical path and is incident on an input side polarization plate 20B. The light transmitting through the input side polarization plate 20B is incident on a liquid crystal panel 21B. The liquid crystal panel 21B constitutes a spatial optical modulation device for modulating the blue light (B) in response to an image signal. The light transmitting through the liquid crystal panel 21B is incident on an output side polarization plate 22B. The blue light (B) transmitting through the output side polarization plate 22B is incident on a cross dichroic prism 23.

The red light (R) and the green light (G) reflected at the first dichroic mirror 14 is incident on a second dichroic mirror 15. The second dichroic mirror 15 reflects the green light (G) and transmits the red light (R). The green light (G) having an optical path bent by reflection at the second dichroic mirror 15 is incident on an input side polarization plate 20G. The green light (G) transmitting through the input side polarization plate 20G is incident on a liquid crystal panel 21G. The liquid crystal panel 21G constitutes a spatial optical modulation device for modulating the green light (G) in response to an image signal. The light transmitting through the liquid crystal panel 21G is incident on an output side polarization plate 22G. The green light (G) transmitting through the output side polarization plate 22G is incident on the cross dichroic prism 23.

An optical path of the red light (R) transmitting through the second dichroic mirror 15 is bent by reflection at a reflection mirror 17, and the red light (R) is incident on a relay lens 18. The optical path of the red light (R) transmitting through the relay lens 18 is bent by reflection at a reflection mirror 19, and the red light (R) is incident on an input side polarization plate 20R. The red light (R) transmitting through the input side polarization plate 20R is incident on a liquid crystal panel 21R. The liquid crystal panel 21R constitutes a spatial optical modulation device for modulating the red light (R) in response to an image signal. The light transmitting through the liquid crystal panel 21R is incident on an output side polarization plate 22R. The red light (R) transmitting through the output side polarization plate 22R is incident on the cross dichroic prism 23.

The cross dichroic prism 23 as a color synthesizing optical system synthesizes the light modulated using each spatial optical modulation device to obtain image light, and makes the image light propagate to a projection optical system 24. The projection optical system 24 projects the image light synthesized by the cross dichroic prism 23 to a screen (not shown).

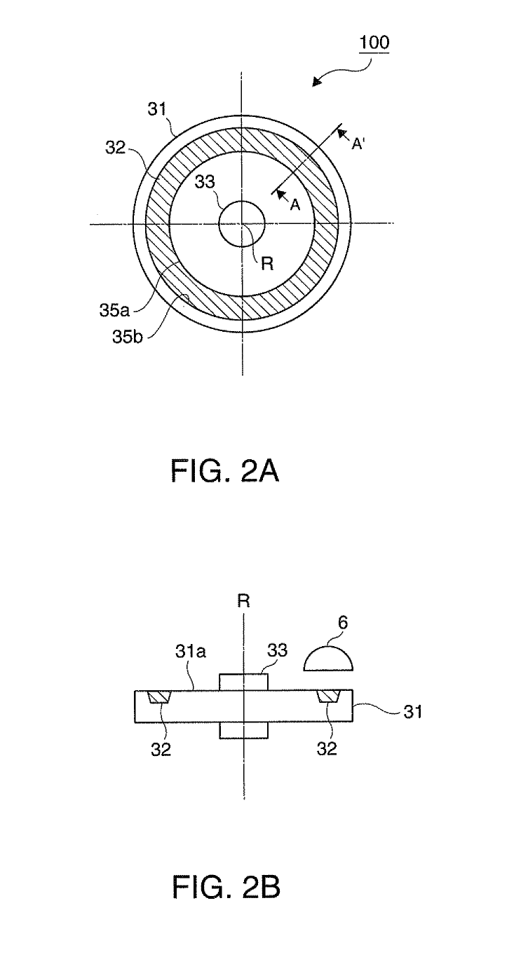

FIG. 2A is a plan view illustrating phosphor wheel 100 serving as a wavelength conversion element, and also a plan view illustrating the phosphor wheel 100 as seen from the side where a structural body 32 is provided. FIG. 2B is a cross-sectional view illustrating the phosphor wheel 100, and shows a cross section including a center position of the phosphor wheel 100. In FIGS. 2A and 2B, a wheel motor 33 is installed in the phosphor wheel 100. In FIG. 2B, the pickup lens 6 is further combined with the phosphor wheel 100.

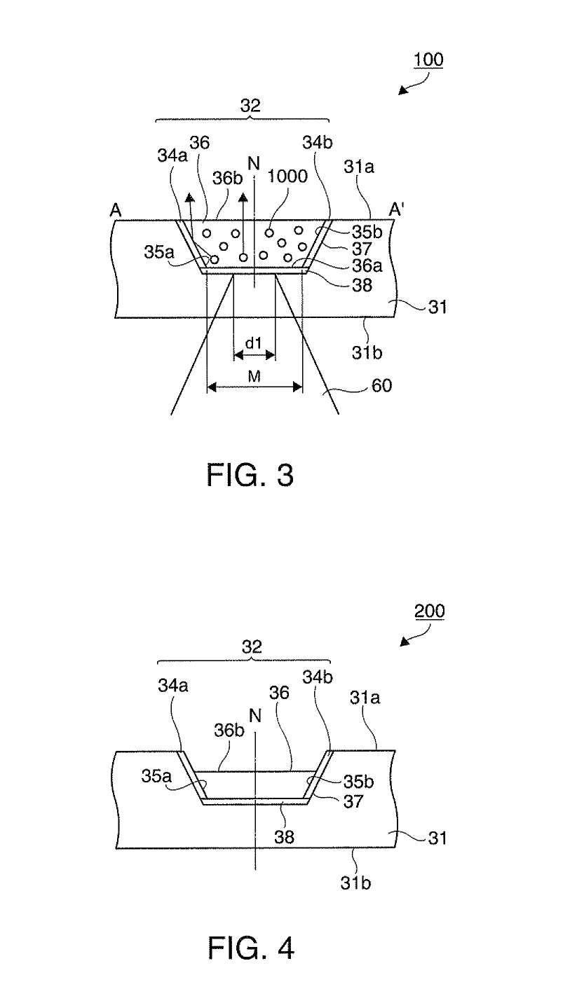

FIG. 3 is a cross-sectional view taken along the line A-A′ in a radial direction of the circle centered at a rotation axis R of the phosphor wheel 100 in FIG. 2A.

The phosphor wheel 100 includes a wheel substrate 31 rotatable around the rotation axis R, and the phosphor wheel 100 also includes the structural body 32.

As shown in FIGS. 2A and 2B, the wheel substrate 31 is a circular plate-shaped member and is made of a transparent member such as glass. The center of the wheel substrate 31 is provided with an opening for penetrating a cylindrical wheel motor 33. In the opening, the wheel substrate 31 is integrated with the wheel motor 33 by installing the wheel substrate 31 in the wheel motor 33. The wheel substrate 31 is rotated by driving the wheel motor 33 with respect to the rotation axis R as the center position of the circular shape. That is, the wheel substrate 31 is rotatable with respect to the rotation axis R which intersects with one surface of the wheel substrate 31.

As shown in FIG. 3, according to the present embodiment, the structural body 32 includes a phosphor layer 36, a first reflective portion 34a, and a second reflective portion 34b. The phosphor layer 36 includes a plurality of phosphor particles 1000. The phosphor layer 36 serves as a light-emitting element. The excitation light 60 is incident from an incident face 36a of the phosphor layer 36 on the phosphor layer 36 to excite the phosphor 1000. The excited phosphor 1000 generates fluorescent light. The fluorescent light generated from the phosphor 1000 and a part of the excitation light 60 transmitting through the phosphor layer 36 are emitted from an emission face 36b of the phosphor layer 36. Hereinafter, in the first to fourth embodiments, one of a plurality of faces of the phosphor layer 36 through which the fluorescent light generated by the phosphor 1000 is emitted from the phosphor layer 36 to the air is referred to as the emission face 36b.

One surface of the wheel substrate 31, that is, the surface 31a of the wheel substrate 31 opposite to a surface 31b through which excitation light 60 is incident on the wheel substrate 31 is provided with a concave portion 37, and the structural body 32 is provided in the concave portion 37. The emission face 36b of the phosphor layer 36 is continuous to the surface 31a of the wheel substrate 31.

As shown in FIG. 2A, the structural body 32 including the phosphor layer 36 has a ring shape having a constant width as seen in a plan view. The ring of the phosphor layer 36 (structural body 32) corresponds to the locus of the spot of the excitation light 60 obtained by rotating the wheel substrate 31 with respect to the rotation axis R.

In FIG. 3, the phosphor layer 36 includes a first side face 35a and a second side face 35b. The first and second side faces 35a and 35b have a circular shape centered at the rotation axis R as seen in a plan view, and they are opposite to each other. The first side face 35a is a side face of the ring-shaped phosphor layer 36 located in the wheel motor 33 side. The second side face 35b is a side face located in the outer circumference side of the wheel substrate 31 of the ring-shaped phosphor layer 36. According to the present embodiment, the first and second side faces 35a and 35b may be collectively called a side face 35 as appropriate.

The first reflective portion 34a is provided in the first side face 35a of the phosphor layer 36, and the second reflective portion 34b is provided in the second side face 35b of the phosphor layer 36. In the cross section intersecting with the first side face 35a, for example, the cross-section A-A′ along the radial direction of the circle centered at the rotation axis R, the distance between the first and second side faces 35a and 35b increases toward the emission face 36b of the fluorescent light from the incident face 36a. Therefore, the distance between the first reflective portion 34a and the second reflective portion 34b also increases toward the emission face 36b of the fluorescent light from the incident face 36a.

According to the present embodiment, the first reflective portion 34a and the second reflective portion 34b may be collectively called a reflective portion 34 as appropriate. Herein, for the brevity purposes, the reflective portion 34 provided in the aforementioned shape is called a tapered reflective portion 34. Alternatively, it is said that the reflective portion 34 has a tapered shape. The reflective portion 34 reflects the fluorescent light emitted from the phosphor layer 36 and the excitation light 60. As the reflective portion 34, a high-reflectance member, for example, a film made of a metal member may be used.

A dichroic film 38 is provided in the incident face 36a interposed between the wheel substrate 31 and the phosphor layer 36 and has a circular shape centered at the rotation axis R as seen in a plan view. The dichroic film 38 serves as a wavelength splitting layer having a wavelength characteristic that transmits the excitation light 60 emitted from the laser diode array 2 and reflects the fluorescent light emitted from the phosphor 1000.

The phosphor 1000 generates fluorescent light including green light (G) and red light (R) by being irradiated with the excitation light 60. A part of the excitation light 60 incident on the phosphor layer 36 is emitted from the emission face 36b of the phosphor layer 36 to the pickup lens 6 along with the fluorescent light. As such, the light source device 10 emits white illumination light by mixing the fluorescent light including the green light (G) and the red light (R) with the excitation light 60 including the blue light (B).

As the phosphor, for example, YAG is used. The phosphor layer 36 is formed, for example, by coating a mixture of the powdery phosphor 1000 and the binder on the wheel substrate 31 and thermally curing the coated mixture.

A spot of the excitation light 60 is formed on the incident face 36a of the phosphor layer 36. The light source device 10 is adjusted such that a spot diameter d1 of the excitation light 60 along the radial direction of the circle centered at the rotation axis R is approximately equal to a width M of the incident face 36a, or is smaller than the width M of the incident face 36a. As a result, the incident position of the excitation light 60, that is, the spot of the excitation light formed in the wavelength conversion element does not get out of the incident face 36a. Therefore, it is possible to increase the allowable range of wobbling of the wavelength conversion element caused by the rotation of the wavelength conversion element.

The excitation light 60 incident on the wheel substrate 31 transmits through the wheel substrate 31 and the dichroic film 38 and is incident on the phosphor layer 36. A part of the excitation light 60 incident on the phosphor layer 36 excites the phosphor 1000, and the excited phosphor 1000 generates the fluorescent light. The fluorescent light generated in the phosphor 1000 is nearly isotropically emitted with respect to the light-emitting position.

The light propagating in parallel with the surface 31a of the wheel substrate 31 inside the phosphor layer 36 or the light propagating with a large angle with respect to a normal line N of the emission face 36b of the phosphor layer 36 is reflected at the reflective portion 34. For this reason, propagation of the fluorescent light in a radial direction of the circle centered at the rotation axis R is restricted, and the light-emitting area is restricted to the area between the first reflective portion 34a and the second reflective portion 34b. That is, the light-emitting area does not exceed the first reflective portion 34a. In addition, the light-emitting area does not exceed the second reflective portion 34b. Therefore, it is possible to suppress the light-emitting area from increasing.

The fluorescent light propagating inside the phosphor layer 36 toward the incident face 36a side of the wheel substrate 31 is reflected at the dichroic film 38 and propagates to the emission face 36b of the phosphor layer 36. For this reason, the fluorescent light generated from the phosphor 1000 is efficiently emitted from the emission face 36b of the phosphor layer 36 without leakage in the incident face 36a side of the wheel substrate 31.

In addition, a component incident on the emission face 36b of the phosphor layer 36 with an angle smaller than a critical angle out of a part of the excitation light 60 transmitting through the phosphor layer 36 is emitted from the phosphor layer 36 to the air. A component incident on the emission face 36b of the phosphor layer 36 with an angle smaller than a critical angle out of a part of the fluorescent light generated from the phosphor 1000 is emitted from the phosphor layer 36 to the air.

By reflecting the light in a direction opposite to the incident face 36a side of the wheel substrate 31 using the tapered reflective portion 34, it is possible to change the propagating direction of the light such that the beam angle with respect to the normal line N of the emission face 36b is reduced. Therefore, the beam angle in the emission face 36b of the phosphor layer 36 is reduced, and the total reflection of the light on the emission face 36b is suppressed. As a result, the light propagating inside the phosphor layer 36 can be easily emitted from the emission face 36b of the phosphor layer 36 to the air.

In addition, since the amount of light reflected at the emission face 36b of the phosphor layer 36 and returned to the phosphor layer 36 is small, optical losses or heat generation caused by absorption of the fluorescent light into the phosphor layer 36 is suppressed.

In addition, by reducing the emission angle (beam angle) of the light emitted from the emission face 36b of the phosphor layer 36, it is possible to increase the amount of light which can be collected by the pickup lens 6 and the like.

In this manner, it is possible to improve the optical use efficiency over the entire system of the projector 1 which includes the phosphor wheel 100.

### First Modification

FIG. 4 is a cross-sectional view illustrating main parts of the phosphor wheel according to a first modification of the present embodiment and corresponds to the cross-sectional view of FIG. 3. In the phosphor wheel 100 according to the first embodiment, the emission face 36b of the phosphor layer 36 and the surface 31a of the wheel substrate 31 are provided to be continuous to each other. However, in a phosphor wheel 200 according to the present modification, the emission face 36b of the phosphor layer 36 is buried inside the concave portion 37 provided in the wheel substrate 31.

The reflective portion 34 is interposed between the side face 35 of the phosphor layer 36 and a wall surface of the concave portion 37. In addition, the reflective portion 34 is not provided only in the side face 35 of the phosphor layer 36. The reflective portion 34 extends from the emission face 36b of the phosphor layer 36 to the vicinity of the surface 31a of the wheel substrate 31 along the wall surface of the concave portion 37. According to the present modification, the reflective portion 34 extends from the emission face 36b of the phosphor layer 36 to the surface 31a of the wheel substrate 31.

In the phosphor wheel 200 according to the present modification, the following effects can be obtained in addition to the effects obtained from the phosphor wheel 100 according to the first embodiment.

Out of the light emitted from the emission face 36b of the phosphor layer 36, the light emitted with a large angle with respect to the normal line N is reflected by the reflective portion 34 toward the pickup lens 6. Therefore, it is possible to increase the amount of light which can be collected by the pickup lens 6. As a result, it is possible to further improve the light use efficiency over the entire system of the projector 1 which includes the phosphor wheel 200.

### Second Modification

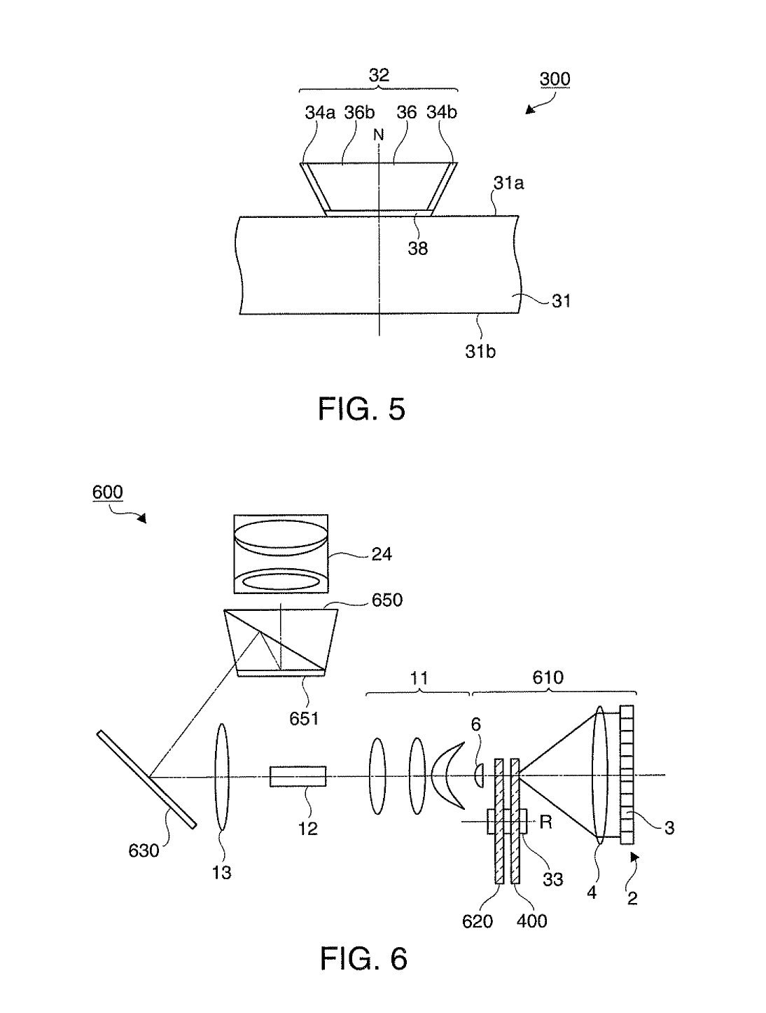

FIG. 5 is a cross-sectional view illustrating the main parts of the phosphor wheel according to a second modification of the present embodiment, and corresponds to the cross-sectional view of FIG. 3. In the phosphor wheel 100 according to the first embodiment, the structural body 32 is buried in the concave portion 37 provided in the wheel substrate 31. However, in a phosphor wheel 300 according to the second modification, the structural body 32 is provided on the surface 31a of the wheel substrate 31.

In the phosphor wheel 300 according to the present modification, an effect of effectively externally radiating the heat generated in the phosphor layer 36 can be obtained in addition to the effects obtained from the phosphor wheel 100 according to the first embodiment.

### Third Modification

Although both the first and second reflective portions 34a and 34b are provided in the phosphor wheel according to the first embodiment and the first and second modifications, only one of the first and second reflective portions 34a and 34b may be provided. For example, in a case where only the second reflective portion 34b is provided, the fluorescent light component propagating with a large angle with respect to the normal line N of the emission face 36b of the phosphor layer 36 toward the outer side of the wheel substrate 31 is restricted by the reflection at the second reflective portion 34b. The light reflected by the second reflective portion 34b propagates through the inner side of the phosphor layer 36 while scattered by the phosphor 1000, and is then emitted from the emission face 36b to the air. Therefore, even when only one of the first and second reflective portions 34a and 34b is provided, it is possible to improve the optical use efficiency over the entire system.

### Second Embodiment

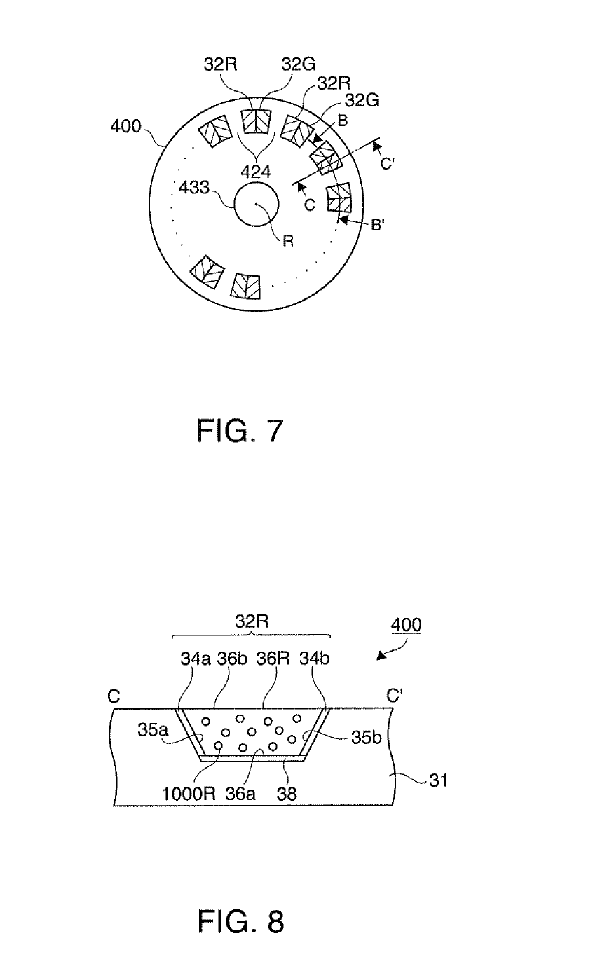

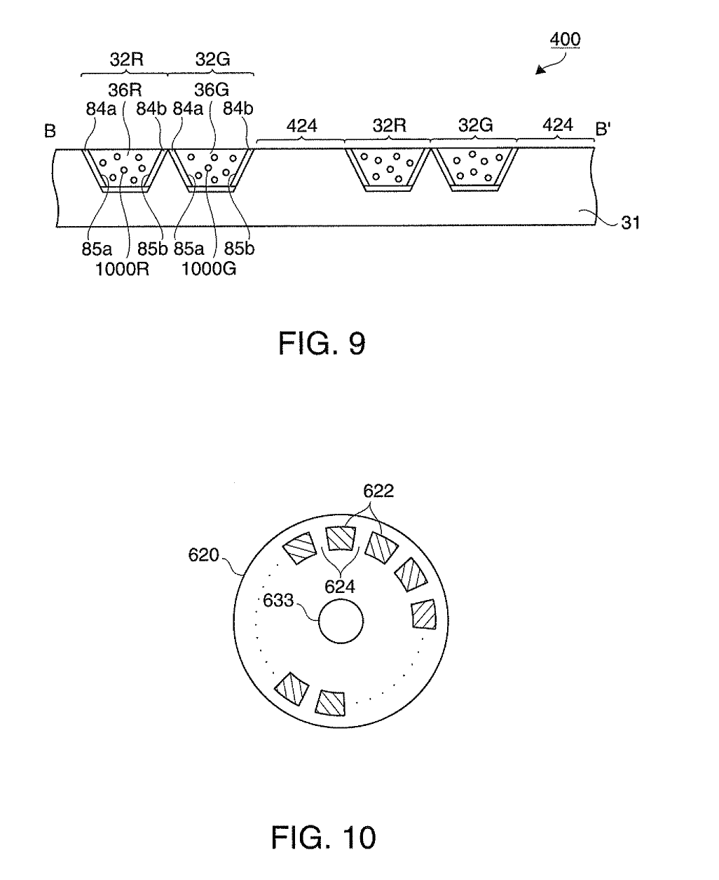

The projector according to a second embodiment will be described with reference to FIGS. 6 to 10. FIG. 6 is a schematic configuration diagram illustrating a projector 600 according to the second embodiment of the invention. FIG. 7 is a plan view illustrating a phosphor wheel 400. FIG. 8 is a diagram illustrating a cross section C-C″ of the phosphor wheel 400. FIG. 9 is a diagram illustrating a cross section B-B″ of the phosphor wheel 400. FIG. 10 is a plan view illustrating a filter 620.

While a single ring-shaped structural body 32 is provided in the wheel substrate 31 according to the first embodiment, in the phosphor wheel 400 according to the present embodiment, as shown in FIG. 7, a plurality of structural bodies 32R and a plurality of structural bodies 32G are arranged in a ring shape to surround the rotation axis R of the wheel substrate 31. In addition, an opening 433 is provided to penetrate through the cylindrical wheel motor 33. The structural body 32R has a phosphor layer 36R including a phosphor 1000R for generating red fluorescent light excited by the excitation light 60. The structural body 32G has a phosphor layer 36G including a phosphor 1000G for generating green fluorescent light excited by the excitation light 60. Similar to the first embodiment, the excitation light 60 is blue light having a wavelength of about 450 nm.

The structural body 32R will be described with reference to FIGS. 8 and 9. The structural body 32G has a structure similar to that of the structural body 32R, and description of the structural body 32G will be emitted. The structural body 32R includes the phosphor layer 36R, a first reflective portion 34a, a second reflective portion 34b, a third reflective portion 84a, and a fourth reflective portion 84b. Phosphor particle 1000R are distributed in the phosphor layer 36R. The excitation light 60 is incident from the incident face 36a side of the phosphor layer 36R to the phosphor layer 36R to excite the phosphor particles 1000R. The excited phosphor 1000R generates red fluorescent light. A part of the excitation light 60 transmitting through the phosphor layer 36R and a part of the fluorescent light generated from the phosphor 1000R are emitted from the emission face 36b of the phosphor layer 36R.

As shown in FIG. 8, the phosphor layer 36R has first and second side faces 35a and 35b. The first and second side faces 35a and 35b have a circular shape centered at the rotation axis R of the wheel substrate 31 as seen in a plan view and are opposite to each other in a radial direction of the circle. The first side face 35a is a side face in the wheel motor 33 side of the phosphor layer 36, and the second side face 35b is a side face in the outer edge side of the wheel substrate 31 of the phosphor layer 36. The first reflective portion 34a is provided in the first side face 35a of the phosphor layer 36R, and the second reflective portion 34b is provided in the second side face 35b of the phosphor layer 36R. Similar to the phosphor wheel 100 according to the first embodiment, in the cross section intersecting with the first side face 35a, for example, the cross section C-C′ in the radial direction of the circle centered at the rotation axis R, the distance between the first and second side faces 35a and 35b increases toward the emission face 36b from the incident face 36a. Therefore, the distance between the first and second reflective portions 34a and 34b also increases toward the emission face 36b from the incident face 36a.

As shown in FIG. 9, the phosphor layer 36R further includes a third side face 85a and a fourth side face 85b extending in the radial direction of the circle centered at the rotation axis R of the wheel substrate 31. The third and fourth side faces 85a and 85b are opposite to each other in the circumferential direction of the circle. The third reflective portion 84a is provided in the third side face 85a of the phosphor layer 36R, and the fourth reflective portion 84b is provided in the fourth side face 85b of the phosphor layer 36R. In the cross section intersecting with the third side face 85a, for example, the cross section B-B′ in the circumferential direction of the circle centered at the rotation axis R, the distance between the third and fourth side faces 85a and 85b increases toward the emission face 36b from the incident face 36a. Therefore, the distance between the third and fourth reflective portions 84a and 84b also increases toward the emission face 36b from the incident face 36a.

According to the present embodiment, the first and second side faces 35a and 35b may be collectively called a side face 35, and the third and fourth side faces 85a and 85b may be collectively called a side face 85 as appropriate. In addition, the first and second reflective portions 34a and 34b may be collectively called a reflective portion 34, and the third and fourth reflective portions 84a and 84b may be collectively called a reflective portion 84 as appropriate. Furthermore, similar to the first embodiment, the reflective portions 34 and 84 provided as described above are called a tapered reflective portion, or it is said that the reflective portion has a tapered shape. Since the reflective portions 34 and 84 have a tapered shape, the excitation light 60 and the fluorescent light incident from the phosphor layer 36R are reflected toward the emission face 36b. For example, a film made of a high-reflectance member such as a metallic member is used as the reflective portions 34 and 84.

As shown in FIG. 7, an area 424 having no phosphor is provided between a pair of the structural bodies 32R and 32G and the other pair of the structural bodies 32R and 32G. The pair of structural bodies 32R and 32G and the area 424 having no phosphor are alternately provided in the circumferential direction of the circle centered at the rotation axis R of the wheel substrate 31. The excitation light 60 may transmit through the area 424 having no phosphor. For this reason, as the wheel substrate 31 is rotated, a mixture of blue excitation light and red fluorescent light, a mixture of blue excitation light and green fluorescent light, and the blue excitation light are sequentially emitted from the wheel substrate 31.

Next, the projector 600 using the phosphor wheel 400 will be described with reference to FIG. 6. Description will not be repeated for the members similar to those of the projector 1 according to the first embodiment.

A light source device 610 includes a laser diode array 2, a condensing lens 4, the phosphor wheel 400, the filter 620, and a pickup lens 6.

As shown in FIG. 10, the filter 620 has a plurality of dichroic films 622 for reflecting the excitation light 60 incident from the phosphor wheel 400 side and transmitting the red fluorescent light and the green fluorescent light generated from the phosphor wheel 400. In addition, an area 624 having no dichroic film 622 is provided between two neighboring dichroic films 622. The area 624 having no dichroic film 622 and the area having the dichroic film 622 are alternately provided in the circumferential direction of the circle centered at the rotation axis R of the filter 620. The excitation light 60 may transmit through the area 624 having no dichroic film 622. In addition, a process for scattering the excitation light 60 is performed for the area 624 having no dichroic film 622. For example, in the area 624 having no dichroic film 622, the excitation light 60 may be scattered by roughening the surface of the filter 620.

The filter 620 is also provided with an opening 633 penetrating through the cylindrical wheel motor 33. The filter 620 and the phosphor wheel 400 are installed in the wheel motor 33 such that the dichroic film 622 provided in the filter 620 is overlapped in a plan view with a pair of the structural bodies 32R and 32G provided in the phosphor wheel 400, and the area 624 having no dichroic film 622 of the filter 620 is overlapped in a plan view with the area 424 having no phosphor of the phosphor wheel 400. Since the filter 620 and the phosphor wheel 400 are installed in the wheel motor 33 in this manner, the red light, the blue light, and the green light are sequentially emitted as illumination light from the light source device 610 as the filter 620 and the phosphor wheel 400 are rotated.

The illumination light emitted from the light source device 610 passes through other members and is incident on a mirror device 630. The mirror device 630 may include, for example, a digital micro-mirror device (DMD) manufactured by Texas Instrument Inc., and the like. Each color light incident on the mirror device 630 as illumination light is modulated by the mirror device 630. The modulated light is incident on a prism 650, reflected at the mirror surface of the prism 650, and incident on a reflection plate 651. The light incident on the reflection plate 651 is reflected to a projection optical system 24. The light reflected toward the projection optical system 24 is enlargedly projected onto a screen (not shown) by the projection optical system 24. As a result, a red image, a blue image, and a green image are sequentially projected onto the screen to display a color image.

The phosphor wheel 400 can restrict the light-emitting area in both the circumferential direction and the radial direction and suppress the light-emitting area from increasing by providing the tapered reflective portion 34 in the circumferential direction and the tapered reflection portion 84 in the radial direction. In addition, in the emission face 36b, it is possible to reduce the beam angle with respect to the normal line of the emission face 36b. As a result, it is possible to further improve the light use efficiency over the entire system of the projector 600 which includes the phosphor wheel 400.

### Third Embodiment

FIG. 11 is a cross-sectional view illustrating the main parts of a phosphor wheel 700 serving as a wavelength conversion element according to a third embodiment of the invention. Description will be made for differences from the phosphor wheel 100 of the first embodiment. In the phosphor wheel 700 according to the present embodiment, instead of the dichroic film 38, a reflection layer 72 for reflecting the fluorescent light and the excitation light 60 is provided in a position corresponding to the incident face 36a of the phosphor layer 36 in the structural body 32 of the first embodiment.

The excitation light 60 is irradiated from the side where the structural body 32 of the wheel substrate 31 is provided to the phosphor 1000 (not shown), and the fluorescent light is generated from the phosphor 1000. Therefore, according to the present embodiment, the emission face 36b of the fluorescent light of the phosphor layer 36 also serves as an incident face on which the excitation light is incident. The fluorescent light propagating inside the phosphor layer 36 toward the wheel substrate 31 is reflected at the reflection layer 72. Therefore, the fluorescent light generated from the phosphor 1000 does not leak in the wheel substrate 31 side and can be emitted efficiently from the emission face 36b of the phosphor layer 36. In addition, the excitation light 60 propagating inside the phosphor layer 36 toward the wheel substrate 31 is also reflected at the reflection layer 72 and can be emitted efficiently from the emission face 36b of the phosphor layer 36.

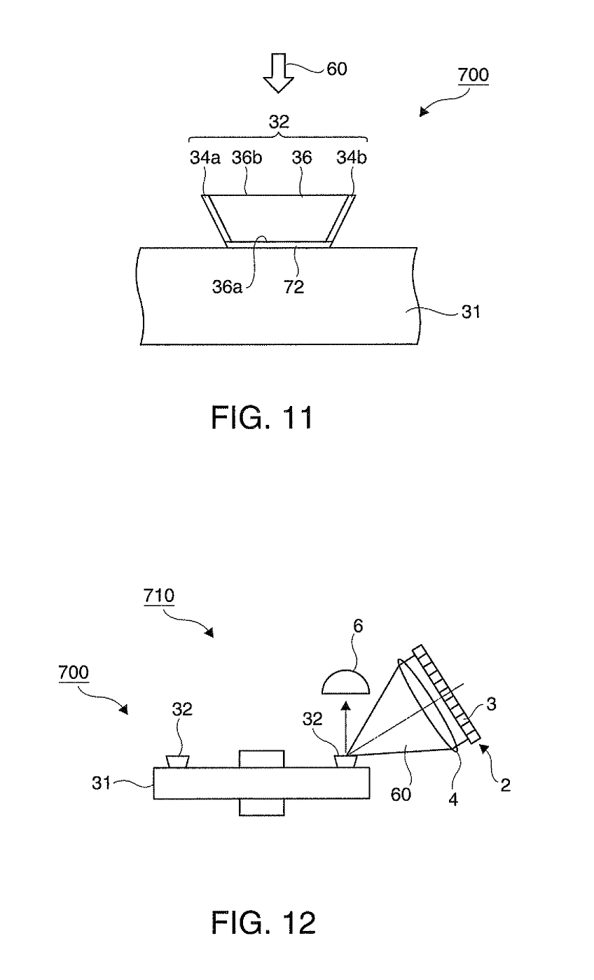

FIG. 12 illustrates a light source device 710 using the phosphor wheel 700. The excitation light 60 is irradiated from the side where the structural body 32 of the wheel substrate 31 is provided to the phosphor 1000, and the fluorescent light generated from the phosphor 1000 and apart of the excitation light 60 are captured by the pickup lens 6. The light captured by the pickup lens 6 propagates to the collimator optical system 11 described in conjunction with the first embodiment. As a result, the light source device 710 serves as a light source of the projector. Similar to the transmissive wheel substrate 31 described in conjunction with the first embodiment, it is possible to improve the optical use efficiency over the entire system even using such a reflective wheel substrate 31.

In the case of the reflective phosphor wheel 700, it is not necessary to use a transparent member as the wheel substrate 31. If metal is used in the wheel substrate 31, it is possible to effectively radiate the heat generated in the phosphor 1000. In this case, as described in conjunction with the first embodiment or the first modification, the phosphor layer 36 is preferably provided in the trench provided on the surface of the wheel substrate. In this configuration, it is possible to more efficiently radiate the heat generated in the phosphor 1000. Furthermore, if metal such as aluminum having a high reflectance is used, the wheel substrate itself serves as the reflective portion 34, the reflective portion 84, or the reflection layer 72. Therefore, it is not necessary to separately provide the reflective portion 34 or the reflection layer 72.

### Fourth Embodiment

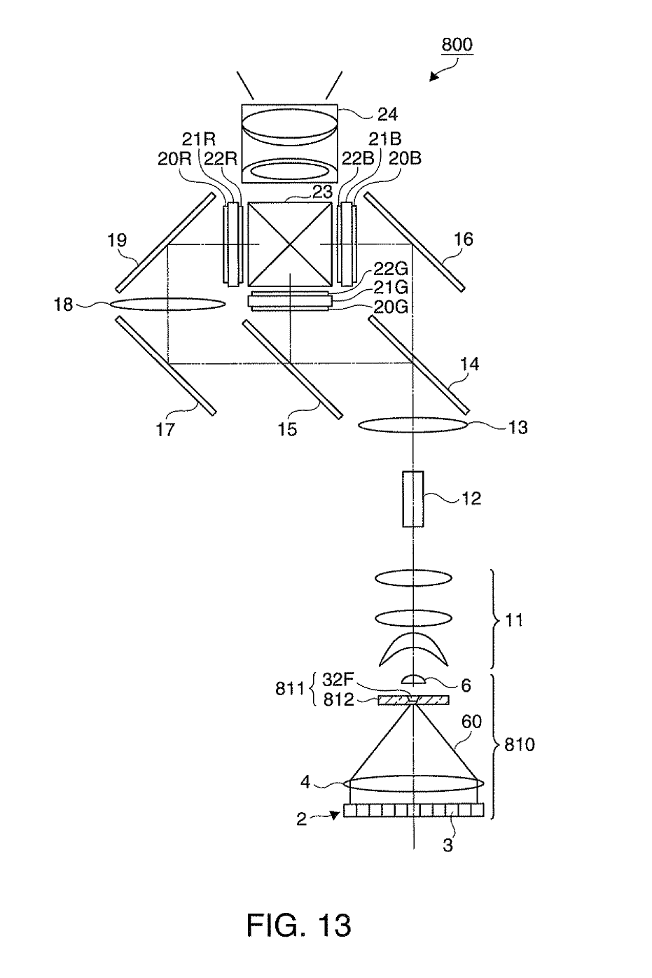

FIG. 13 is a schematic configuration diagram illustrating a projector according to the fourth embodiment of the invention.

In the first to third embodiments described above, the phosphor wheel 100 rotatable by a motor is exemplarily used as the wavelength conversion element. In comparison, in a projector 800 according to the present embodiment, a fluorescent substrate 811 is used as the wavelength conversion element used in a light source device 810. The fluorescent substrate 811 includes a substrate mainframe 812 and a structural body 32F.

As shown in FIG. 13, the substrate mainframe 812 is a plate-shaped member made of a transparent member such as glass. The structural body 32F has the same configuration as that of the structural body 32R or 32G described in conjunction with the second embodiment. That is, the structural body 32F includes a phosphor layer, a first reflective portion, a second reflective portion, a third reflective portion, and a fourth reflective portion. In order to efficiently use the excitation light, it is preferable that a spot of the excitation light formed on the fluorescent substrate 811 does not exceed the incident face 36a of the phosphor layer 36. In addition, it is more preferable that the area of the incident face 36a of the phosphor layer 36 be equal to the area of the spot of the excitation light. One surface of the substrate mainframe 812, that is, the surface opposite to the surface of the substrate mainframe 812 where the excitation light 60 is incident is provided with a concave portion, and the structural body 32F is provided in the concave portion. The fluorescent substrate 811 according to the present embodiment is fixed and not rotated unlike the phosphor wheels of the first to third embodiments described above.

Similar to the first to third embodiments described above, the projector 800 according to the present embodiment is provided with the reflective portion on the side face of the phosphor layer. Therefore, the light propagating inside the phosphor layer is easily emitted from the emission face of the phosphor layer to the air. As a result, it is possible to improve the optical use efficiency over the entire system of the projector which includes the fluorescent substrate.

The phosphor wheels 31 according to each embodiment are not limited to the projector 1 in which a transmissive liquid crystal panel is used as the spatial optical modulation device or the projector 600 in which the mirror device is used as the spatial optical modulation device. The phosphor wheel may also be applied to the projector having a reflective liquid crystal on silicon (LCOS).

### Fifth Embodiment

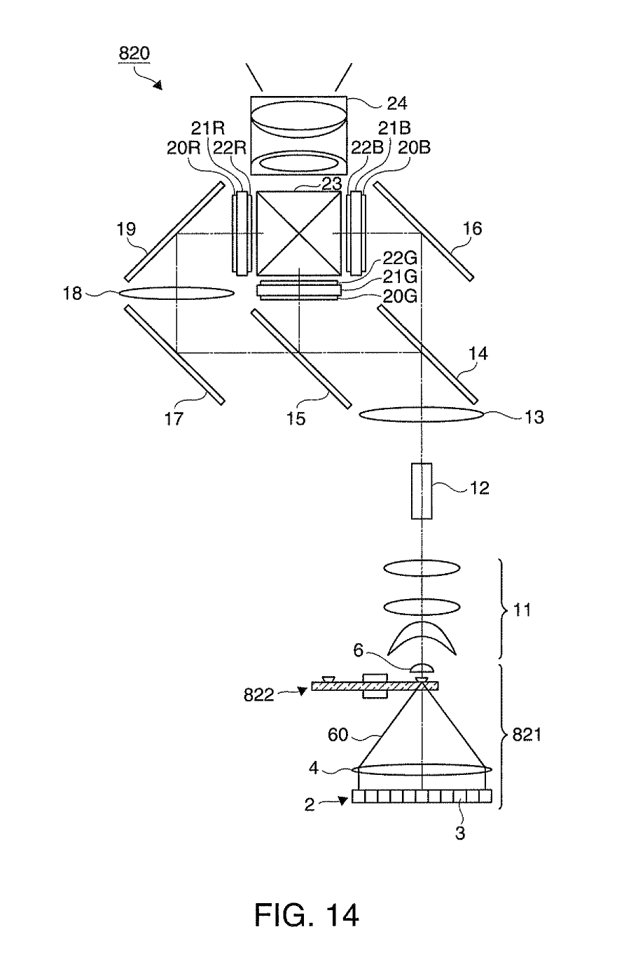

FIG. 14 is a schematic configuration diagram illustrating a projector 820 according to the fifth embodiment of the invention.

A basic configuration of the projector 820 according to the present embodiment is similar to that of the projector of the first embodiment, but the configuration of the phosphor wheel is different. Therefore, in FIG. 14, like reference numerals denote like elements as in FIG. 1.

A light source device 821 emits illumination light including red light (R), green light (G), and blue light (B). The light source device 821 includes a laser diode array 2, a condensing lens 4, a phosphor wheel 822 serving as a wavelength conversion element, and a pickup lens 6.

The laser diode array 2 includes a plurality of laser diodes 3 arranged in an array shape. The laser diode array 2 serves as an excitation light source unit for emitting the excitation light 60.

The excitation light 60 is, for example, blue light (B) having a wavelength of about 450 nm. The condensing lens 4 serves as a condensing optical system for condensing the excitation light 60 emitted from the laser diode array 2 onto the phosphor wheel 822. The phosphor wheel 822 emits the fluorescent light having a wavelength different from that of the excitation light 60 by being irradiated with the excitation light 60. The pickup lens 6 is provided in the optical path of the excitation light 60. The pickup lens 6 captures the fluorescent light emitted from the phosphor wheel 822 and the excitation light 60 transmitting through the phosphor wheel 822 and then makes them propagate through the collimator optical system 11.

The collimator optical system 11 condenses the light from the light source device 821 onto the rod integrator 12. The rod integrator 12 internally multi-reflects the incident light and collimates the light. The superposition lens 13 superposes a plurality of light beams split by the rod integrator 12 into the spatial optical modulation device.

The first dichroic mirror 14 reflects the green light (G) and the red light (R) incident from the superposition lens 13 and transmits the blue light (B). The blue light (B) transmitting through the first dichroic mirror 14 is reflected at the reflection mirror 16 to bend the optical path and is incident on the input side polarization plate 2013. The light transmitting through the input side polarization plate 20B is incident on the liquid crystal panel 21B. The liquid crystal panel 21B constitutes a spatial optical modulation device for modulating the blue light (B) in response to the image signal. The light transmitting through the liquid crystal panel 21B is incident on the output side polarization plate 22B. The light transmitting through the output side polarization plate 22B is incident on the cross dichroic prism 23.

The green light (G) and the red light (R) reflected at the first dichroic mirror 14 are incident on the second dichroic mirror 15. The second dichroic mirror 15 reflects the green light (G) and transmits the red light (R). The green light (G) having an optical path bent by reflection at the second dichroic mirror 15 is incident on the input side polarization plate 20G. The green light (G) transmitting through the input side polarization plate 20G is incident on the liquid crystal panel 21G. The liquid crystal panel 21G constitutes a spatial optical modulation device for modulating the green light (G) in response to the image signal. The light transmitting through the liquid crystal panel 21G is incident on the output side polarization plate 22G. The light transmitting through the output side polarization plate 22G is incident on the cross dichroic prism 23.

The red light (R) transmitting through the second dichroic mirror 15 is reflected at the reflection mirror 17 to bend the optical path and is incident on the relay lens 18. The red light (R) transmitting through the relay lens 18 is reflected at the reflection mirror 19 to bend the optical path and is incident on the input side polarization plate 20R. The red light (R) transmitting through the input side polarization plate 20R is incident on the liquid crystal panel 21R. The liquid crystal panel 21R constitutes a spatial optical modulation device for modulating the red light (R) in response to the image signal. The light transmitting through the liquid crystal panel 21R is incident on the output side polarization plate 22R. The light transmitting through the output side polarization plate 22R is incident on the cross dichroic prism 23.

The cross dichroic prism 23 as a color synthesizing optical system synthesizes the light modulated by each spatial optical modulation device to provide image light, and makes the light propagate to the projection optical system 24. The projection optical system 24 projects the image light synthesized by the cross dichroic prism 23 onto a screen (not shown).

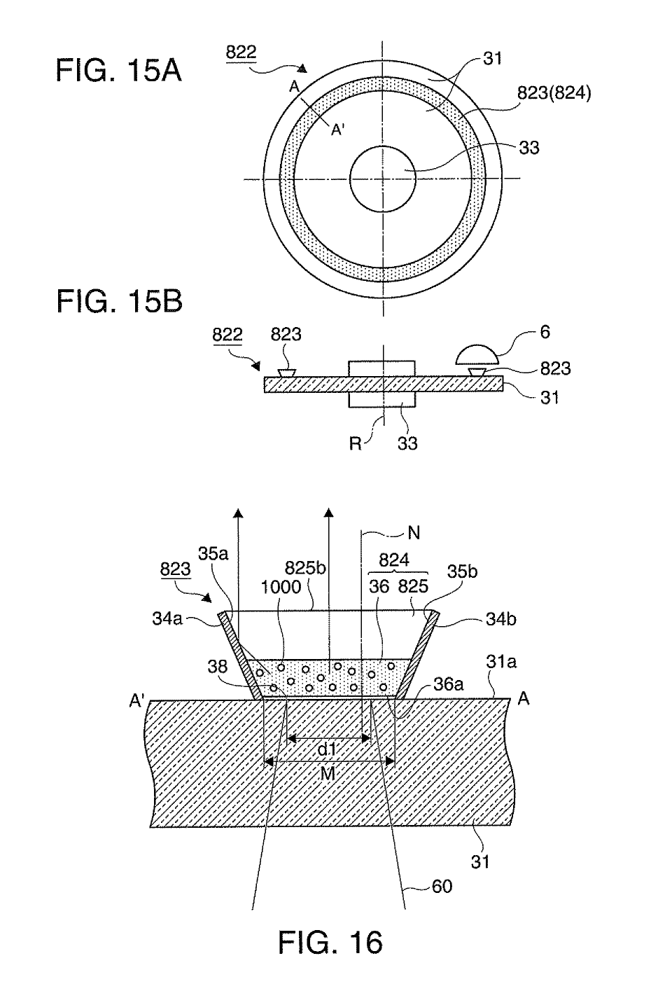

FIG. 15A is a plan view illustrating the phosphor wheel 822 serving as a wavelength conversion element, and FIG. 15B is a cross-sectional view illustrating the phosphor wheel 822. In FIGS. 15A and 15B, the wheel motor 33 is installed in the phosphor wheel 822. In FIG. 15B, the pickup lens 6 is further combined with the phosphor wheel 822. The phosphor wheel 822 further includes a structural body 823 and a wheel substrate 31 rotatable with respect to the rotation axis R. The structural body 823 will be described below. The plan view illustrating the phosphor wheel 822 of FIG. 15A is a plan view when the phosphor wheel 822 is seen from the side where the structural body 823 is provided. In addition, the cross-sectional view illustrating the phosphor wheel 822 of FIG. 15B is a cross-sectional view including a center position of the phosphor wheel 822. FIG. 16 illustrates the cross section A-A′ of the phosphor wheel 822 along the radial direction of the circle centered at the rotation axis R of the wheel substrate 31.

As shown in FIGS. 15A and 15B, the wheel substrate is a circular plate-shaped member and is made of a transparent member such as glass. The center of the wheel substrate 31 is provided with an opening penetrating through the cylindrical wheel motor 33. By installing the wheel substrate 31 in the wheel motor 33 using the opening, the wheel substrate 31 is integrated with the wheel motor 33. The wheel substrate 31 is rotated by driving the wheel motor 33 with respect to the center position of the circular shape as the rotation axis R.

As shown in FIG. 16, according to the present embodiment, the structural body 823 includes a light-emitting element 824, a first reflective portion 34a, and a second reflective portion 34b. The light-emitting element 824 includes a light-transmitting layer 825 and a phosphor layer 36 including a plurality of phosphor particles 1000. The phosphor 1000 is excited by being irradiated with the excitation light 60 to generate the fluorescent light. The phosphor layer 36 has a binder made of transparent resin, in which a plurality of phosphor particles 1000 are distributed. The light-transmitting layer 825 is provided in the side of the phosphor layer 36 opposite to the wheel substrate 31, and transmits the light incident from the phosphor layer 36.

The structural body 823 is provided on the surface 31a of a plurality of surfaces of the wheel substrate 31 opposite to the side where the excitation light 60 is incident. As shown in FIG. 15A, the light-emitting element 824 of the structural body 823 has a ring shape having a constant width as seen in a plan view. The ring of the light-emitting element 824 corresponds to the locus of the spot of the excitation light 60 obtained by rotating the wheel substrate 31.

The phosphor wheel 822 is capable of efficiently externally radiating the heat generated from the phosphor 1000 by proving the structural bodies 823 on the surface of the wheel substrate 31.

As shown in FIG. 16, the light-emitting element 824 includes first and second side faces 35a and 35b having a circular shape centered at the rotation axis R of the wheel substrate 31 as seen in a plan view. The first and second side faces 35a and 35b are opposite to each other. The first side face 35a is a side face of the ring-shaped light-emitting element 824 in the wheel motor 33 side. The second side face 35b is a side face of the ring-shaped light-emitting element 824 in the outer circumference side of the wheel substrate 31. According to the present embodiment, the first and second side faces 35a and 35b may be collectively called a side face 35 as appropriate.

The first reflective portion 34a is provided in the first side face 35a of the light-emitting element 824, and the second reflective portion 34b is provided in the second side face 35b of the light-emitting element 824. In the cross section intersecting with the first side face 35a, for example, the cross section along the radial direction of the circle centered at the rotation axis R, the distance between the first and second side faces 35a and 35b increases toward the light-transmitting layer 825 from the phosphor layer 36. Therefore, the distance between the first and second reflective portions 34a and 34b also increases toward the light-transmitting layer 825 from the phosphor layer 36. According to the present embodiment, the first and second reflective portions 34a and 34b may be collectively called a reflective portion 34 as appropriate. In addition, herein, for brevity purposes, the reflective portion provided in the manner described above is called a tapered reflective portion. Otherwise, it is said that the reflective portion has a tapered shape. The reflective portion 34 reflects the excitation light and the fluorescent light incident from the phosphor layer 36, and the reflective portion 34 further reflects the excitation light and the fluorescent light incident from the light-transmitting layer 825. As the reflective portion 34, a film made of a high-reflectance member, for example, a metallic member is used.

The dichroic film 38 is provided between the wheel substrate 31 and the phosphor layer 36. The interface between the wheel substrate 31 and the phosphor layer 36 is an incident face 36a on which the excitation light 60 is incident. The dichroic film 38 serves as a wavelength splitting layer having a wavelength characteristic that transmits the excitation light 60 emitted from the laser diode array 2 and reflects the fluorescent light emitted from the phosphor 1000.

The phosphor 1000 generates the fluorescent light including the green light (G) and the red light (R) by being irradiated with the excitation light 60. A part of the excitation light 60 incident on the phosphor layer 36 is emitted toward the pickup lens 6 from the phosphor layer 36 along with the fluorescent light. As such, the light source device 821 emits white illumination light by mixing the fluorescent light including the green light (G) and the red light (R) with the excitation light 60 including the blue light (B). As the phosphor 1000, for example, a phosphor made of YAG is used. The phosphor layer 36 is obtained, for example, by coating a mixture of the phosphor particles 1000 and a binder on the wheel substrate 31 and thermally curing the mixture. The light-transmitting layer 825 is made of transparent resin having a refractive index equal to that of the binder of the phosphor layer 36.

The spot of the excitation light 60 is formed in the incident face 36a of the phosphor layer 36. In the light source device 821, the spot diameter d1 of the excitation light 60 measured in the radial direction of the circle centered at the rotation axis R is adjusted to be approximately equal to the width M of the incident face 36a in the radial direction or be smaller than the width M of the incident face 36a in the radial direction. Therefore, it is possible to increase the allowable range of the wobbling, the allowable range being required for the incidence position of the excitation light 60, that is, the spot of the excitation light formed in the wavelength conversion element not to get out of, or not to exceed, the incident face 36a, of the phosphor wheel 822 caused by rotation of the phosphor wheel 822.

The excitation light 60 incident on the wheel substrate 31 transmits through the wheel substrate 31 and the dichroic film 38 and is incident on the phosphor layer 36. A part of the excitation light 60 incident on the phosphor layer 36 excites the phosphor 1000, and the excited phosphor 1000 generates the fluorescent light. The fluorescent light generated from the phosphor 1000 is nearly isotropically emitted while centered at the light-emitting position.

The component incident on the interface between the light-transmitting layer 825 and the air with an angle smaller than a critical angle out of the excitation light 60 and the fluorescent light propagating from the phosphor layer 36 to the light-transmitting layer 825 is emitted from the emission face 825b of the light-transmitting layer 825 to the air.

According to the present embodiment, since the refractive index of the light-transmitting layer 825 is equal to the refractive index of the binder of the phosphor layer 36, the light is not reflected at the interface between the phosphor layer 36 and the light-transmitting layer 825. For this reason, neither the fluorescent light emitted from the phosphor 1000 nor the excitation light scattered by the phosphor 1000 is reflected at the interface between the phosphor layer 36 and the light-transmitting layer 825, and consequently, neither the fluorescent light nor the excitation light returns to the phosphor layer 36. As a result, it is possible to suppress optical losses or heat generation caused by absorption of the fluorescent light into the phosphor layer 36. In addition, the light-transmitting layer 825 may be made of, for example, a material having the refractive index lower than that of the binder, without being limited to a material having a refractive index equal to that of the binder.

The fluorescent light propagating inside the phosphor layer 36 toward the wheel substrate 31 is reflected at the dichroic film 38 and propagates to the light-transmitting layer 825. For this reason, the fluorescent light generated from the phosphor 1000 does not leak to the wheel substrate 31 side and can be efficiently emitted from the fluorescent light emission face 825b of the light-transmitting layer 825. Hereinafter, according to the fifth to tenth embodiments, the fluorescent light emission face 825b means the face where the fluorescent light from the phosphor 1000 is emitted from the light-transmitting layer 825 to the air out of a plurality of faces of the light-transmitting layer 825.

In addition, it is possible to change the propagation direction of the light using the tapered reflective portion 34 such that the beam angle with respect to the normal line N of the wheel substrate 31 is reduced. Therefore, the beam angle on the fluorescent light emission face 825b of the light-transmitting layer 825 is reduced, and the total reflection of the light at the interface between the light-transmitting layer 825 and the air is suppressed. As a result, the light propagating inside the light-transmitting layer 825 is easily emitted from the fluorescent light emission face 825b of the light-transmitting layer 825 to the air.

In addition, the fluorescent component propagating inside the phosphor layer 36 in parallel with the wheel substrate 31 is reflected at the reflective portion 34, and propagation in the radial direction of the phosphor wheel 822 is suppressed. In the phosphor wheel 822 according to the present embodiment, propagation of the fluorescent light in the phosphor layer 36 is suppressed by the reflective portion 34. Therefore, it is possible to suppress the light-emitting area in the phosphor layer 36 from increasing.

By reducing the emission angle of the light emitted from the fluorescent light emission face 825b of the light-transmitting layer 825, it is possible to increase the amount of the light which can be collected by the pickup lens 6 and the like. As a result, it is possible to improve the optical use efficiency over the entire system of the projector 820 which includes the phosphor wheel 822.

### First Modification

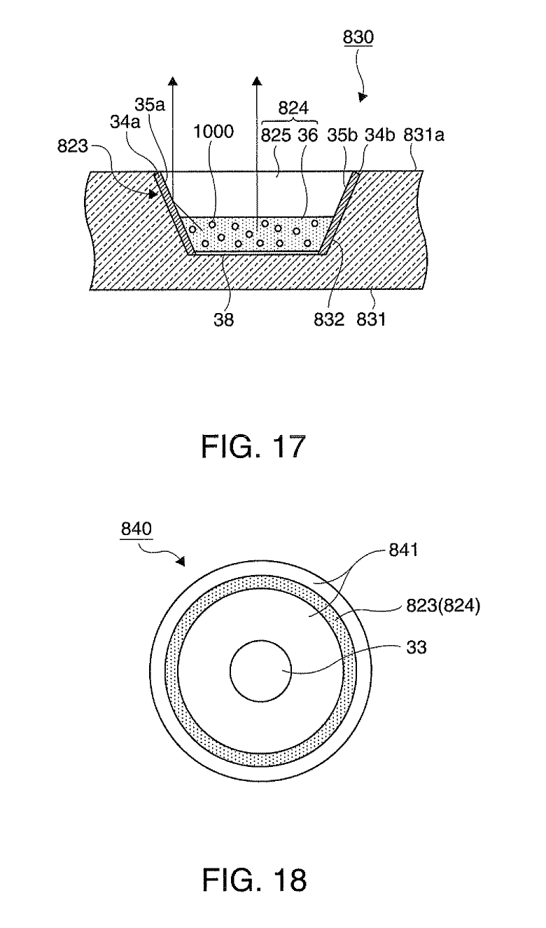

FIG. 17 is a cross-sectional view illustrating main parts of a phosphor wheel 830 according to the first modification of the present embodiment. In the phosphor wheel 822 according to the fifth embodiment, the structural body 823 is provided on the surface 31a out of a plurality of surfaces of the wheel substrate 31 opposite to the side where the excitation light 60 is incident. However, in the phosphor wheel 830 according to the present modification, the structural body 823 is provided in a trench 832 provided on a surface 831a of a wheel substrate 831. The reflective portion 34 is interposed between a wall surface of the trench 832 and the side face 35 of the light-emitting element 824. The dichroic film 38 is provided in a bottom face of the trench 832. Since the phosphor layer 36 is provided in the trench 832, it is possible to stably coat the material of the phosphor layer 36.

### Second Modification

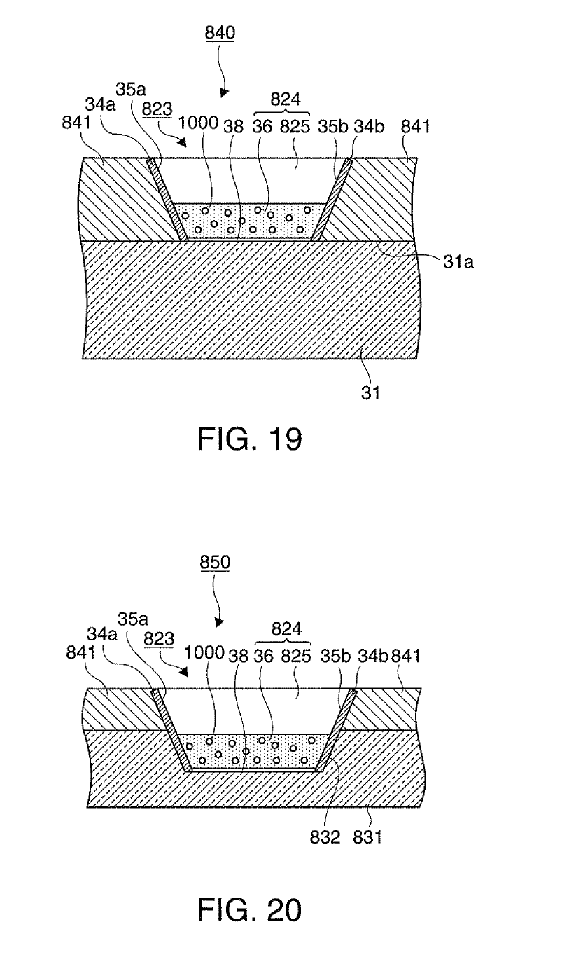

FIG. 18 is a plan view illustrating a phosphor wheel 840 according to the second modification of the present embodiment. FIG. 19 is a cross-sectional view illustrating main parts of the phosphor wheel 840. The phosphor wheel 840 according to the present modification has a heat conduction portion 841 for conducting the heat from the phosphor 1000. The heat conduction portion 841 is provided adjacently to the structural body 823 on the surface 31a of the wheel substrate 31. The heat conduction portion 841 is made of a member having a high heat conductivity such as aluminum or copper.

The heat generated from the phosphor 1000 by being irradiated with the excitation light 60 is conducted to the heat conduction portion 841 from the phosphor layer 36 through the reflective portion 34 or from the phosphor layer 36 through the light-transmitting layer 825 and the reflective portion 34. The phosphor wheel 840 can effectively radiate the heat generated from the phosphor 1000 by providing the heat conduction portion 841. The phosphor wheel 840 can generate the fluorescent light with a high efficiency by effectively radiating the heat.

The heat conduction portion 841 is not limited to the case where the part other than the structural body 823 out of the surface of the wheel substrate 31 is perfectly covered. The heat conduction portion 841 is to be provided in at least a part of the surface 31a of the wheel substrate 31 in the vicinity of the structural body 823 in order to effectively radiate the heat generated from the phosphor 1000. In the phosphor wheel 840, the reflective portion 34 may be provided between the side face 35 of the light-emitting element 824 and the heat conduction portion 841, or a part of the heat conduction portion 841 may serve as the reflective portion.

### Third Modification

FIG. 20 is a cross-sectional view illustrating main parts of a phosphor wheel 850 according to the third modification of the present embodiment. In the phosphor wheel 850 according to the present modification, the structural body 823 is provided in the trench 832 formed in the heat conduction portion 841 and the wheel substrate 831. Similarly, according to the present modification, the phosphor wheel 850 is capable of effectively radiating the heat generated from the phosphor 1000 by providing the heat conduction portion 841. The heat conduction portion 841 may be configured to perfectly cover the part other than the trench 832 out of the surface of the wheel substrate 831 or may be provided in part in the vicinity of the structural body 823.

### Fourth Modification

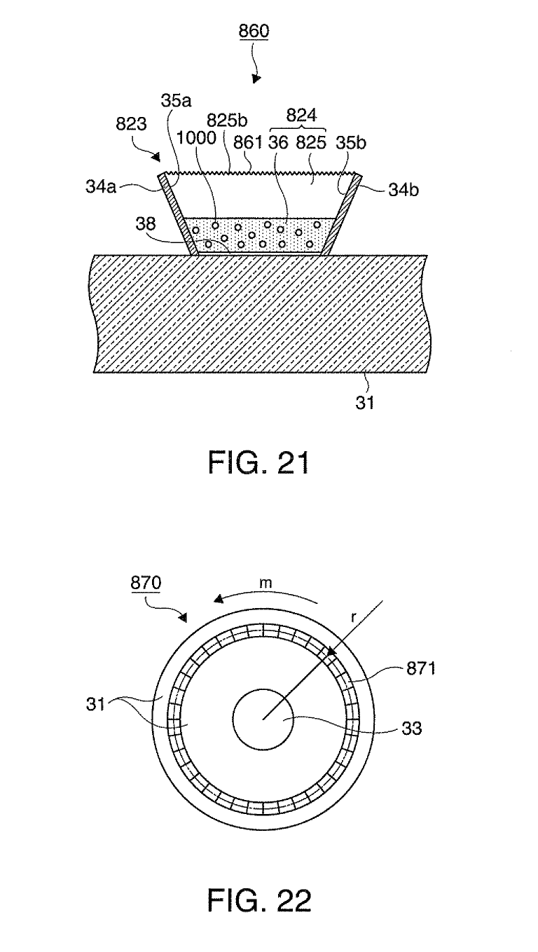

FIG. 21 is a cross-sectional view illustrating main parts of a phosphor wheel 860 according to the fourth modification of the present embodiment. The phosphor wheel 860 according to the present modification has an embossed structure (moth-eye structure) 861 provided on the fluorescent light emission face 825b of the light-transmitting layer 825.

Each embossed structure 861 is provided in a two-dimensional manner, for example, in a width shorter than the wavelength of the fluorescent light. The embossed structure 861 suppresses reflection of the light at the interface between the light-transmitting layer 825 and the air. The phosphor wheel 860 according to the present modification can efficiently extract the light from the light-transmitting layer 825 due to the embossed structure 861.

### Fifth Modification

Although both the first and second reflective portions 34a and 34b are provided in the phosphor wheels according to the fifth embodiment and the first to fourth modifications, only one of the first and second reflective portions 34a and 34b may be provided. For example, in a case where only the second reflective portion 34b is provided, the fluorescent component propagating with a large angle with respect to the normal line N is suppressed from propagating to the outer side of the wheel substrate 31 due to reflection at the second reflective portion 34b. The light reflected by the second reflective portion 34b propagates inside the phosphor layer 36 while scattered by the phosphor 1000, and enters the light-transmitting layer 825. Therefore, even when only one of the first and second reflective portions 34a and 34b is provided, it is possible to improve the optical use efficiency over the entire system.

### Sixth Embodiment

FIG. 22 is a plan view illustrating a phosphor wheel 870 serving as the wavelength conversion element according to the sixth embodiment of the invention. According to the present embodiment, the reflective portion is provided on the side face provided in a circular shape centered at the rotation axis R of the wheel substrate 31 and the side face provided in the radial direction of the circle. The phosphor wheel 870 is applied to the light source device 810 of the fifth embodiment. In the present embodiment, like reference numerals denote like elements as in the fifth embodiment, and description thereof will not be repeated. The structural body including the phosphor layer is divided into a plurality of unit structural bodies 871 by the reflective portion arranged in the circumferential direction.

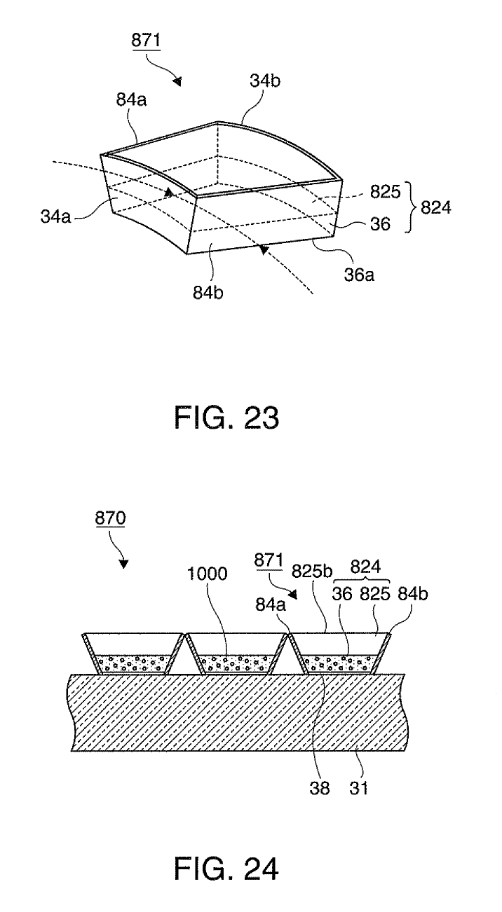

FIG. 23 is a perspective view illustrating a single unit structural body 871. The unit structural body 871 includes a light-emitting element 824, first and second reflective portions 34a and 34b provided in the circumferential direction, and third and fourth reflective portions 84a and 84b provided in the radial direction. The light-emitting element 824 includes the light-transmitting layer 825 and the phosphor layer 36 including the particulate phosphor 1000. As such, the light-emitting element 824 is surrounded by the first, second, third, and fourth reflective portions 34a, 34b, 84a, and 84b. Similar to the reflective portion 34 (refer to FIG. 16) of the fifth embodiment, the first and second reflective portions 34a and 34b provided in the circumferential direction in a single unit structural body 871 have a tapered shape in a cross section along the radial direction of the circle. According to the present embodiment, the first and second reflective positions 34a and 34b may be collectively called a reflective portion 34 as appropriate. Similarly, the third and fourth reflective portions 84a and 84b may be collectively called a reflective portion 84.

FIG. 24 is a cross-sectional view illustrating the main parts of the phosphor wheel 870 in a circumferential direction indicated as a one-dotted chain line in FIG. 22. A plurality of unit structural bodies 871 are divided by the reflective portions 84 and arranged side by side in a circumferential direction. The dichroic film 38 as the wavelength splitting layer is provided between the wheel substrate 31 and the phosphor layer 36 of each unit structural body 871. The reflective portion 84 provided in a radial direction in a single unit structural body 871 has a tapered shape in the cross section along the circumferential direction.

In the phosphor wheel 870 according to the present embodiment, the reflective portion 34 having a tapered shape is provided in a circumferential direction, and the reflective portion 84 having a tapered shape is provided in a radial direction. Therefore, the light-emitting area is restricted in both the radial direction and the circumferential direction. For this reason, it is possible to suppress the light-emitting area from increasing, and further it is possible to reduce the beam angle on the fluorescent light emission face 825b of the light-transmitting layer 825. As a result, it is possible to further improve the optical use efficiency over the entire system of the projector which includes the phosphor wheel 870.

As shown in FIG. 24, an area having no phosphor 1000 exists between the neighboring two unit structural bodies 871. Here, the laser diode array 2 (refer to FIG. 14) emits the excitation light 60 at a pulse frequency depending on the rotation of the phosphor wheel 870 such that the excitation light 60 is not irradiated onto the area having no phosphor 1000, that is, the excitation light 60 is appropriately incident on the phosphor layer 36 of each unit structural body 871. The light source device 821 can improve the optical use efficiency by stopping the emission of the excitation light 60 onto the area having no phosphor 1000 and stabilize the strength of the light emitted from the light source device 821. In addition, using the pulse light-emission, it is possible to increase the lifetime of the laser diode 3.

In a case where a single pulse of the excitation light 60 is incident on the phosphor wheel 870, the length L of the irradiation area in the circumferential direction can be computed using Equation (1).

L=d2+2πrmD/F (1),

where, d2 denotes a spot diameter (m) of the excitation light 60 in a circumferential direction, r denotes a distance (m) between the rotation center R and the center of the light-emitting element 824 in a radial direction, m denotes a rotation number (rps) of the phosphor wheel 870, D denotes a duty ratio of the pulse of the excitation light 60, and F denotes a pulse frequency (Hz) of the excitation light 60. As shown in FIG. 23, since the length of the incident face 36a of the phosphor layer 36 in a circumferential direction is set to L, it is possible to suitably irradiate the excitation light 60 onto the unit structural body 871.

If the length L is allowed to increase up to T times the spot diameter d2, that is, if blur of the excitation light 60 up to T times the spot diameter d2, Equation (2) regarding the distance r can be obtained by applying T=L/d2 to Equation (1) as follows.

r=(T−1)d2F/(2πrmD) (2).

For example, if the pulse frequency F is set to 100 kHz, the duty ratio D is set to 0.3, the spot diameter d2 is set to 1 mm, the rotation number m is set to 10000/60 rps (=10000 rpm), and T is set to 1.1, the distance r is computed to be approximately 3.2 cm using Equation (2). In this case, the length of a single unit structural body 871 in a circumferential direction becomes approximately 1.1 mm. In the light source device 821, irradiation of the excitation light 60 by the laser diode array 2 and rotation of the phosphor wheel 870 are synchronized with each other using the design and the driving based on such computations.

A number S of the structural bodies 871 formed in the phosphor wheel 870 is obtained based on S=F/m. Since S is an integer, F is an integer multiple of m. As a result, the laser diode array 2 can appropriately irradiate the excitation light 60 onto the light-emitting element 824 of each unit structural body 871 except for the area having no phosphor 1000.

The phosphor wheel of each embodiment is not limited to the case applied to a projector having a transmissive liquid crystal panel as a spatial optical modulation device. The phosphor wheel may be applied to a projector having a reflective liquid crystal on silicon (LCOS) or digital micromirror device (DMD).

### Seventh Embodiment

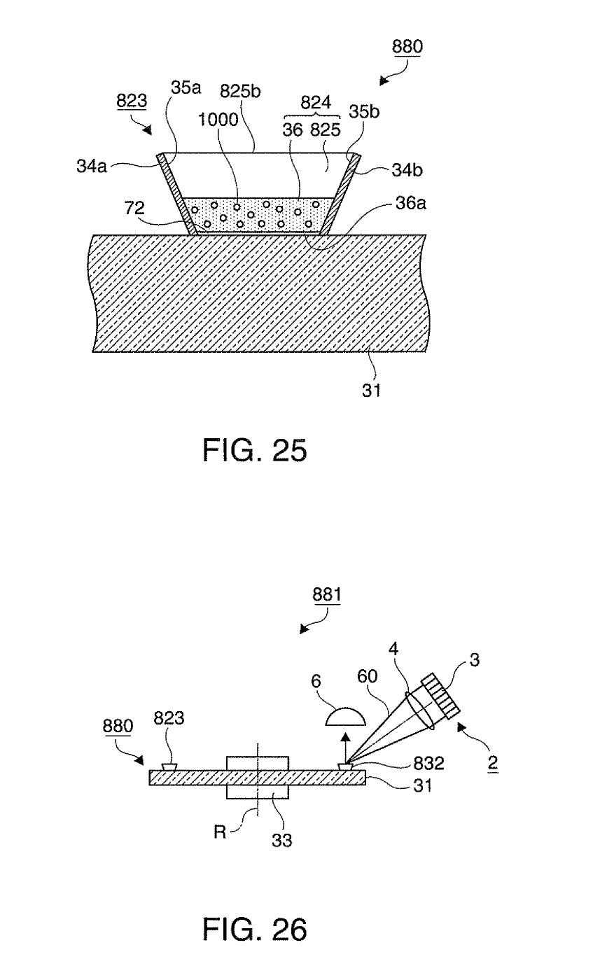

FIG. 25 is a cross-sectional view illustrating main parts of a phosphor wheel 880 serving as a wavelength conversion element according to the seventh embodiment of the invention. Description will be made for differences from the phosphor wheel 822 according to the fifth embodiment. In the phosphor wheel 880 according to the present embodiment, a reflection layer 72 for reflecting the excitation light 60 and the fluorescent light is provided instead of the dichroic film 38 in a position corresponding to the incident face 36a of the phosphor layer 36 of the structural body 823 of the fifth embodiment. The excitation light 60 is irradiated onto the phosphor 1000 from the side where the structural body 823 of the wheel substrate 31 is provided. Therefore, according to the present embodiment, the fluorescent light emission face 825b of the light-transmitting layer 825 is also an incident face through which the excitation light is incident on the phosphor layer 36.

The fluorescent light propagating inside the phosphor layer 36 toward the wheel substrate 31 is reflected at the reflection layer 72 and propagates to the direction of the light-transmitting layer 825. For this reason, the fluorescent light generated from the phosphor 1000 does not leak to the wheel substrate 31 side and can be efficiently emitted from the fluorescent light emission face 825b of the light-transmitting layer 825. Similarly, the excitation light propagating inside the phosphor layer 36 toward the wheel substrate 31 is reflected at the reflection layer 72 and can be efficiently emitted from the fluorescent light emission face 825b of the light-transmitting layer 825.

FIG. 26 illustrates an exemplary light source device 881 using the phosphor wheel 880. The excitation light 60 is irradiated from the side, where the structural body 823 of the wheel substrate 31 is provided, to the phosphor 1000. A part of the excitation light 60 and the fluorescent light generated from the phosphor 1000 are captured by the pickup lens 6. The light captured by the pickup lens 6 propagates to the collimator optical system 11 described in conjunction with the fifth embodiment. As a result, the light source device 881 is used as a light source of the projector. Similar to the transmissive wheel substrate described in conjunction with the fifth embodiment, it is possible to improve the optical use efficiency of the entire system even in such a reflective wheel substrate.

In the case of the reflective phosphor wheel 880, it is not necessary to use a transparent member as the wheel substrate 31. If metal is used in the wheel substrate, it is possible to effectively radiate the heat generated from the phosphor 1000. In this case, as shown in the first modification of the fifth embodiment, it is preferable that the light-emitting element 824 be provided in the trench 832 provided on the surface of the wheel substrate 831. In this configuration, it is possible to more efficiently radiate the heat generated from the phosphor 1000. Furthermore, if metal having a high optical reflectivity such as aluminum is used, the wheel substrate itself serves as the reflection member. Therefore, it is not necessary to prepare the reflective portion 34 or the reflection layer 72.

### Eighth Embodiment

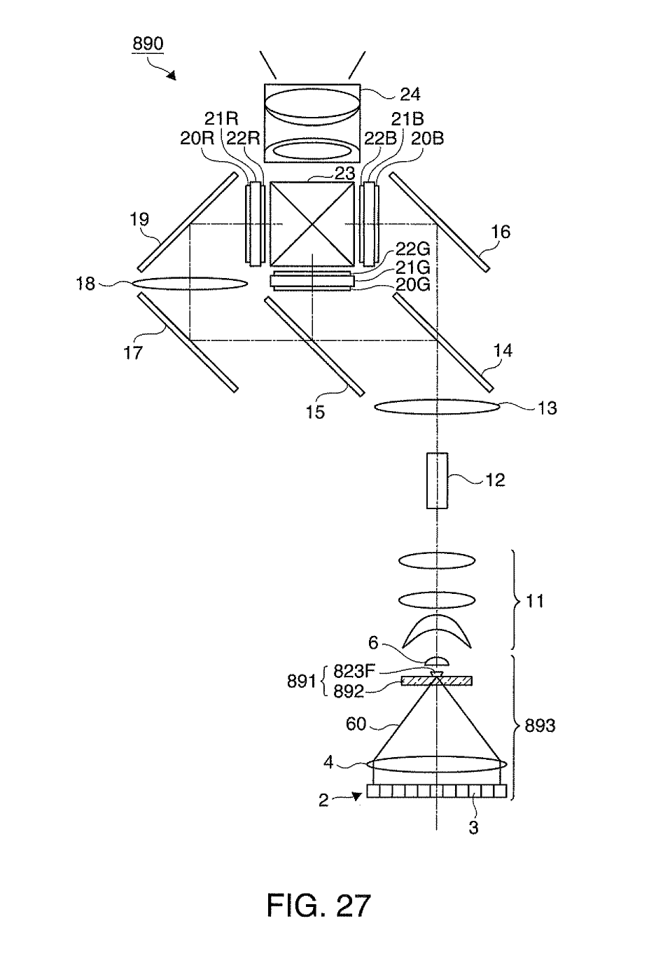

FIG. 27 is a schematic configuration diagram illustrating a projector 890 according to the eighth embodiment of the invention.

In the fifth to seventh embodiments described above, an example using the phosphor wheel rotatable by the wheel motor 33 is illustrated as the wavelength conversion element. In comparison, in the projector 890 according to the present embodiment, as the wavelength conversion element used in a light source device 893, a fluorescent substrate 891 is used. The fluorescent substrate 891 has a substrate mainframe 892 and a structural body 823F.

As shown in FIG. 27, the substrate mainframe 892 is a plate-shaped member made of a transparent member such as glass. According to the present embodiment, the structural body 823F has the same configuration as that of the structural body 871 described in conjunction with the sixth embodiment. That is, the unit structural body 871 includes a light-emitting element 824, first and second reflective portions 34a and 34b provided in a circumferential direction, and third and fourth reflective portions 84a and 84b provided in a radial direction. In order to efficiently use the excitation light, it is preferable that a spot of the excitation light formed on the fluorescent substrate 891 does not exceed the incident face 36a of the phosphor layer 36. In addition, it is preferable that the area of the incident face 36a of the phosphor layer 36 be equal to the area of the spot of the excitation light. One surface of the substrate mainframe 892, that is, the surface opposite to the surface of the substrate mainframe 892 where the excitation light 60 is incident is provided with the structural body 823F. The fluorescent substrate 891 according to the present embodiment is fixed and not rotated unlike the phosphor wheels according to the fifth to seventh embodiments described above.

Similar to the fifth to seventh embodiments described above, in the projector 890 according to the present embodiment, the light propagating inside the phosphor layer is easily emitted to the air from the emission face of the phosphor layer. As a result, it is possible to improve the optical use efficiency over the entire system of the projector which includes the fluorescent substrate.

### Ninth Embodiment

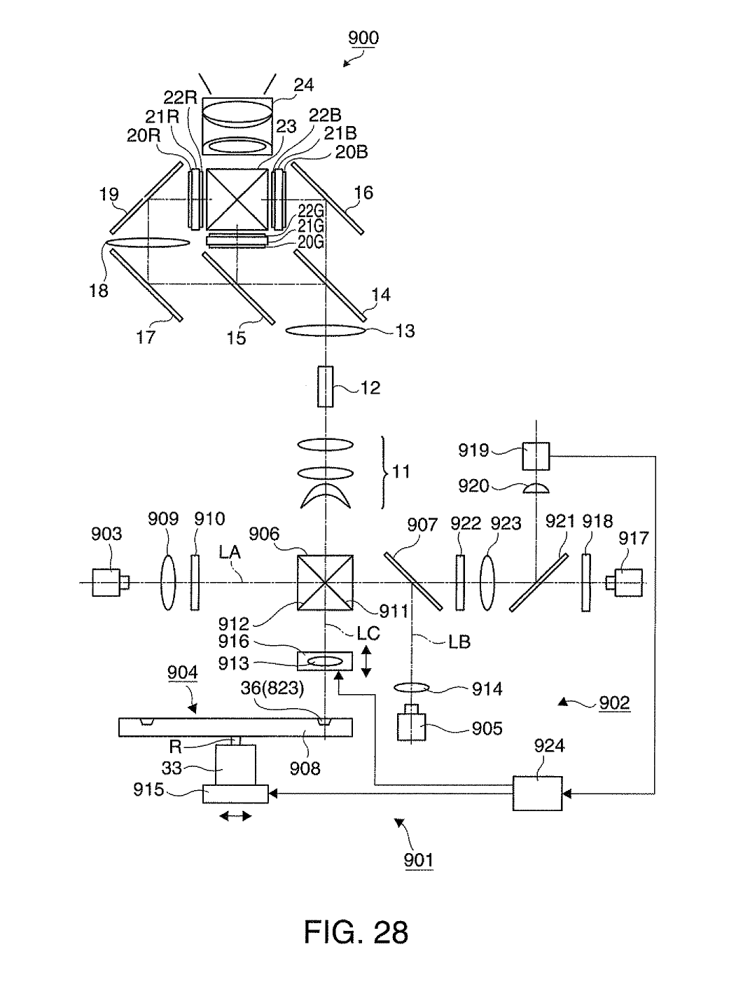

FIG. 28 is a schematic configuration diagram illustrating a projector 900 according to the ninth embodiment of the present embodiment.

Out of the projector 900 according to the present embodiment, the configuration in a rear stage of the collimator optical system 11 is similar to that of the projector according to the first embodiment. In the projector 900 according to the present embodiment, unlike the projector of the first embodiment, the configuration of a light source device 901 in a front stage of the collimator optical system 11 includes a correction unit 902 for correcting a positional deviation of the incidence face through which the excitation light is incident on the light-emitting element 824 Specifically, the incident face through which the excitation light is incident on the light-emitting element 824 is an area between the end of the first reflective portion 34a opposite to the wheel substrate 31 and the end of the second reflective portion 34b opposite to the wheel substrate 31. Hereinafter, the incident face through which the excitation light is incident on the light-emitting element 824 will be simply referred to as an incident face of the light-emitting element 824.

In FIG. 28, like reference numerals denote like elements as in FIG. 1 of the first embodiment, and detailed description thereof will not be repeated.

As shown in FIG. 28, the light source device 901 according to the present embodiment mainly includes an ultraviolet laser diode 903, a phosphor wheel 904, a blue-color laser diode 905, a cross dichroic prism 906, a dichroic mirror 907, and a correction unit 902. The ultraviolet laser diode 903 serves as an excitation light source unit for emitting ultraviolet light as the excitation light. The phosphor wheel 904 is rotated by the wheel motor 33, and serves as the wavelength conversion element for emitting a fluorescent light by being irradiated with the excitation light. The correction unit 902 corrects a positional deviation of the incident face of the light-emitting element 824 caused by rotation of the phosphor wheel 904. The configuration and the function of the correction unit 902 will be described in detail below.

The phosphor wheel 904 includes a wheel substrate 908 and a structural body 823 provided in the trench formed on the main surface of the wheel substrate 908. Similar to the fifth embodiment, the structural body 823 includes a phosphor layer 36 and a reflective portion, and the light-emitting element 824 includes a phosphor layer 36 and a light-transmitting layer 825. The configuration of the structural body 823 has been described in conjunction with the fifth embodiment, and thus, detailed description of the structural body 823 will not be repeated. In addition, according to the present embodiment, similar to the phosphor wheel 880 according to the seventh embodiment, the excitation light is irradiated onto the phosphor 1000 from the side where the structural body 823 of the wheel substrate 908 is provided. Therefore, according to the present embodiment, the fluorescent light emission face 825b of the light-transmitting layer 825 corresponds to the incident face of the light-emitting element 824. The wheel substrate 908 according to the present embodiment is a circular plate-shaped member and is made of a metal material such as aluminum. The center of the wheel substrate 908 is provided with a rotation axis R connected to the wheel motor 33. The wheel substrate 908 is rotated by driving the wheel motor 33 at a rotational velocity of, for example, 7200 rpm with respect to the rotation axis R. The phosphor wheel 904 is rotatable with respect to the rotation axis R intersecting with one surface of the wheel substrate 908. For this reason, it can be said that a spot of the excitation light formed on the phosphor wheel 904 is moved temporally on the phosphor wheel 904. In addition, the phosphor layer 36 is provided along the circle centered at the rotation axis R on one surface of the wheel substrate 908.

According to the present embodiment, the wheel substrate 908 is made of an aluminum disk having a diameter of, for example, 40 mm. One surface of the aluminum disk is provided with a trench having, for example, an inner diameter of 37 mm, an outer diameter of 38.3 mm, a width (the dimension in a radial direction of the wheel substrate 908) of 1.3 mm, and a depth of 0.15 mm. That is, the width of the fluorescent light emission face 825b of the structural body 823 is set to 1.3 mm. In addition, the width of the bottom face of the structural body 823 corresponding to the incident face 36a which the excitation light is incident on according to the seventh embodiment is set to 1 mm. In addition, in order to facilitate correction of the positional deviation described below, in the cross section of the structural body 823 in a radial direction of the wheel substrate 908, it is preferable that an inclination angle of the first side face 35a with respect to one main surface of the wheel substrate 908 be equal to an inclination angle of the second side face 35b with respect to the one main surface of the wheel substrate 908.

A silver film as a reflection film is formed on the inner surface of the trench. In addition, a protection film made of silicon oxide is formed on the surface of the silver film. Silicon resin, in which, for example, phosphor particles which generate yellow light having a wavelength of 500 to 700 nm by being excited by the ultraviolet light having a wavelength of, for example, 405 nm are distributed and included, is buried in the inner side of the trench. The phosphor layer 36 is made of silicon resin in which a plurality of phosphor particles are distributed and included. Since the silver film is formed on the inner surface of the trench, the yellow light generated from the phosphor layer 36 is efficiently extracted from the phosphor wheel 904.

The ultraviolet laser diode 903 emits ultraviolet light having a wavelength of, for example, 405 nm as the excitation light for exciting the phosphor layer 36. The ultraviolet light emitted from the ultraviolet laser diode 903 is collimated by a first collimator lens 909 to form beams using a computer generated hologram (CGH) 910, and the beams are incident on the cross dichroic prism 906. The optical axis of the light emitted from the ultraviolet laser diode 903, that is, the optical axis passing through the first collimator lens 909, the CGH 910, and the cross dichroic prism 906 will be referred to as an optical axis LA.

The cross dichroic prism 906 includes a first wavelength splitting film 911 that reflects the light having a wavelength shorter than 500 nm and transmits the light having a wavelength equal to or longer than 500 nm and a second wavelength splitting film 912 that reflects the light having a wavelength equal to or longer than 700 nm and transmits the light having a wavelength shorter than 700 nm. The ultraviolet light incident on the cross dichroic prism 906 is reflected at the first wavelength splitting film 911 to bend the optical axis by 90° and is directed to the phosphor wheel 904. The optical axis of ultraviolet light (excitation light) reflected at the first wavelength splitting film 911 and bent by 90° is referred to as an optical axis LC.

A pickup lens 913 is provided between the cross dichroic prism 906 and the phosphor wheel 904. The ultraviolet light emitted from the ultraviolet laser diode 903 is condensed onto the phosphor layer 36 of the phosphor wheel 904 through the first collimator lens 909, the CGH 910, and the pickup lens 913. Since the position of the pickup lens 913 on the optical axis LC is optimized by a second actuator described below, the ultraviolet light is focused as a rectangular spot (light source image) having a width of 1.2 mm on the wheel substrate 908. The size of the spot of the ultraviolet light is set to 1.2 mm in width, and one side of the rectangular spot approximately corresponds with the radial direction of the wheel substrate 908. That is, a size W1 of the spot in the cross section in a radial direction of the wheel substrate 908 is set to 1.2 mm. In addition, a width W2 of the incident face of the light-emitting element 824 in the cross section in the radial direction of the wheel substrate 908 is set to 1.3 mm. For this reason, if a suitable positional relationship is established between the condensing position of the excitation light and the phosphor layer 36, the condensing position of the excitation light is positioned in the incident face of the light-emitting element 824, that is, positioned on the fluorescent light emission face 825b of the light-transmitting layer 825. Furthermore, the spot of the excitation light formed on the wheel substrate 908 does not get out the incident face of the light-emitting element 824. According to the present embodiment, the size W1 of the spot is slightly smaller than the width W2 of the incident face of the light-emitting element 824. However, in order to effectively use both the excitation light and the phosphor layer 36, the size W1 of the spot is preferably equal to the width W2 of the incident face of the light-emitting element 824.

When the ultraviolet light is incident on the phosphor layer 36, the phosphor is excited by ultraviolet light and generates yellow light having a wavelength of 500 to 700 nm. The yellow light generated from the phosphor is incident on the cross dichroic prism 906 through the pickup lens 913, transmits through the first and second wavelength splitting films 911 and 912, and is directed to the collimator optical system 11 in the rear stage. Meanwhile, in the optical axis LA, a dichroic mirror 907 that reflects the light having a wavelength shorter than 500 nm and transmits the light having a wavelength equal to or longer than 500 nm is provided in a side of the cross dichroic prism 906 opposite to the side where the ultraviolet laser diode 903 is provided.

If an optical axis which is perpendicular to the optical axis LA and passes the dichroic mirror 907 is set to an optical axis LB, the blue-color laser diode 905 that emits blue light having a wavelength of, for example, 460 nm is provided on the optical axis LB. A second collimator lens 914 is provided between the dichroic mirror 907 and the blue-color laser diode 905. The blue light emitted from the blue-color laser diode 905 is collimated by the second collimator lens 914, and then incident on the dichroic mirror 907. The blue light is reflected at the dichroic mirror 907 and incident on the dichroic prism 906. The blue light incident on the dichroic mirror 906 is reflected at the first wavelength splitting film 911 and directed to the collimator optical system 11 in the rear stage. As a result, the yellow light generated from the phosphor layer 36 and the blue light emitted from the blue-color laser diode 905 are synthesized to provide white light, and the white light is incident on the collimator optical system 11.

The correction unit 902 includes a first actuator 915, a second actuator 916, an infrared laser diode 917, a diffractive grating 918, an optical detector 919, a cylindrical lens 920, a polarized beam splitter 921 (hereinafter, referred to as PBS), a ¼ wavelength plate 922, a third collimator lens 923, and a control unit 924. The wheel motor 33 of the phosphor wheel 904 is provided with the first actuator 915. The first actuator 915 corresponds to a first correction unit that corrects the positional deviation of the incident face of the light-emitting element 824 in the direction perpendicular to the optical axis LC of the excitation light. Such correction is equivalent to correction of a relative positional relationship between the phosphor layer 36 and the spot of the excitation light. By driving the first actuator 915, the phosphor wheel 904 shifts in parallel with the main surface of the wheel substrate 908. In addition, the pickup lens 913 is provided with a second actuator 916. The second actuator 916 corresponds to a second correction unit that corrects the positional deviation of the incident face of the light-emitting element 824 in the direction of the optical axis LC of the excitation light. This correction is equivalent to correction of the size of the spot of the excitation light in a case where the excitation light is not parallel light. By driving the second actuator 916, the pickup lens 913 is shifted in parallel with the optical axis LC.

In the optical axis LA, the ¼ wavelength plate 922, the third collimator lens 923, the PBS 921, the diffractive grating 918, and the infrared laser diode 917 are sequentially arranged in this order from the dichroic mirror 907 in the side of the dichroic mirror 907 opposite to the side where the dichroic prism 906 is provided. The PBS 921 is arranged such that the transmissive axis of the PBS 921 corresponds with a polarization axis of the infrared light emitted from the infrared laser diode 917. The ¼ wavelength plate 922, the third collimator lens 923, the PBS 921, the diffractive grating 918, and the infrared laser diode 917 arranged in the rear stage of the dichroic mirror 907 serve as a detection unit for detecting the amount of the positional deviation of the incident face of the light-emitting element 824.

The infrared laser diode 917 emits infrared light having a wavelength of, for example, 780 nm as detection light for detecting whether or not the incident faces of the light-emitting element 824 and the pickup lens 913 are positioned in suitable locations. The infrared light emitted from the infrared laser diode 917 is divided into three beams by the diffractive grating 918, sequentially transmits through the PBS 921, the third collimator lens 923, the ¼ wavelength plate 922, and the dichroic mirror 907. Then, three beams are incident on the cross dichroic prism 906. The infrared light incident on the cross dichroic prism 906 is reflected at the second wavelength splitting film 912, is incident on the phosphor wheel 904 through the pickup lens 913, and is reflected at the phosphor wheel 904.

The infrared light reflected at the phosphor wheel 904 transmits through the pickup lens 913, is reflected at the second wavelength splitting film 912 of the cross dichroic prism 906, sequentially transmits through the dichroic mirror 907, the ¼ wavelength plate 922, and the third collimator lens 923, and is incident on the PBS 921. In this case, since the infrared light transmits through the ¼ wavelength plate 922 twice in both the forward and backward paths, the polarization axis of the infrared light incident on the PBS 921 is rotated by 90° with respect to the polarization axis of the infrared light just after emitted from the infrared laser diode 917. Therefore, the infrared light is reflected at the PBS 921 and is incident on the optical detector 919 through the cylindrical lens 920.

The optical detector 919 detects a positional deviation, so called, a focusing deviation of the incident face of the light-emitting element 824 from a suitable position in a direction parallel to the optical axis LC based on the incident infrared light. The optical detector 919 further detects a positional deviation, so called, a tracking deviation of the incident face of the light-emitting element 824 from a suitable position in a direction perpendicular to the optical axis LC. Here, for example, a condensing point of the excitation light may be used as the suitable position of the incident face of the light-emitting element 824 in the direction parallel to the optical axis LC. In addition, a position where the spot of the ultraviolet light (excitation light) does not externally exceed the incident face through which the excitation light is incident on the phosphor layer 36 may be used as the suitable position of the incident face of the light-emitting element 824 in the direction perpendicular to the optical axis LC. The focusing deviation is detected based on a fact that the beam shape of the infrared light after transmitting through the cylindrical lens 920 is changed depending on whether the position of the pickup lens 913 is at a best focus position, an image is focused in front of the best focus position, or an image is focused in rear of the best focus position. That is, an astigmatic method known in the art is used to detect the focusing deviation. In addition, the tracking deviation is detected using a main beam and two subsidiary beams based on a fact that the light amount difference between two subsidiary beams is changed depending on the direction of the tracking deviation. That is, the tracking deviation is detected using three beam methods known in the art. In addition, a method of detecting the focusing deviation or the tracking deviation is not limited to the methods described above. For example, Foucault's method may be used to detect the focusing deviation, or a push-pull method may be used to detect the tracking deviation.

The output signal of the optical detector 919 is sent to a control unit 924. The control unit 924 transmits, to the second actuator 916, a driving signal for shifting the pickup lens 913 in the direction parallel to the optical axis LC depending on a deviation amount and the direction of the focusing deviation based on an output signal of the optical detector 919. In addition, the control unit 924 transmits, to the first actuator 915, a driving signal for shifting the phosphor wheel 904 perpendicularly to the optical axis LC depending on the deviation amount and the direction of the tracking deviation based on an output signal of the optical detector 919. The second actuator 916 drives the pickup lens 913 in parallel with the optical axis LC such that the light condensed by the pickup lens 913 is best focused on an incident face of the light-emitting element 824 at all times. This correction corresponds to correction of fluctuation of the spot size by the focusing deviation. As a result, a phenomenon that the spot exceeds the incident face of the light-emitting element 824 can be suppressed, and consequently, degradation of the use efficiency of the excitation light which may be caused by an enlarged spot due to the focusing deviation can be suppressed. In addition, it is possible to reduce fluctuation of the strength of the light emitted from the light source device. The first actuator 915 drives the phosphor wheel 904 perpendicularly to the optical axis LC such that the light condensed by the pickup lens 913, that is, the spot of the excitation light does not get out the incident face of the light-emitting element 824 at all times. This correction corresponds to correction of the relative positional relationship between the phosphor layer 36 and the spot. As a result, it is possible to suppress reduction of the use efficiency of the excitation light which can be caused when the spot exceeds the incident face of the light-emitting element 824. In addition, it is possible to reduce fluctuation of the strength of the light emitted from the light source device.

Similar to the first to eighth embodiments described above, in the projector 900 according to the present embodiment, the light propagating inside the phosphor layer is easily emitted to the air from the emission face of the phosphor layer by providing the reflective portion on the side face of the phosphor layer 36. As a result, it is possible to improve the optical use efficiency over the entire system of the projector.

However, even when various optical components are aligned in appropriate positions while the projector 900 stops, the focusing deviation or the tracking deviation of the excitation light may occur due to the positional deviation of the incident face of the light-emitting element 824 caused by eccentricity or plane wobbling of the wheel substrate 908 under the state that the phosphor wheel 904 is rotated at a high speed by actuating the projector 900. In this regard, according to the present embodiment, since the correction unit 902 for correcting the focusing deviation or the tracking deviation of the excitation light is provided, it is possible to reliably correct the focusing deviation or the tracking deviation in order to suppress fluctuation of the strength of the light emitted from the light source device 901.

### Tenth Embodiment

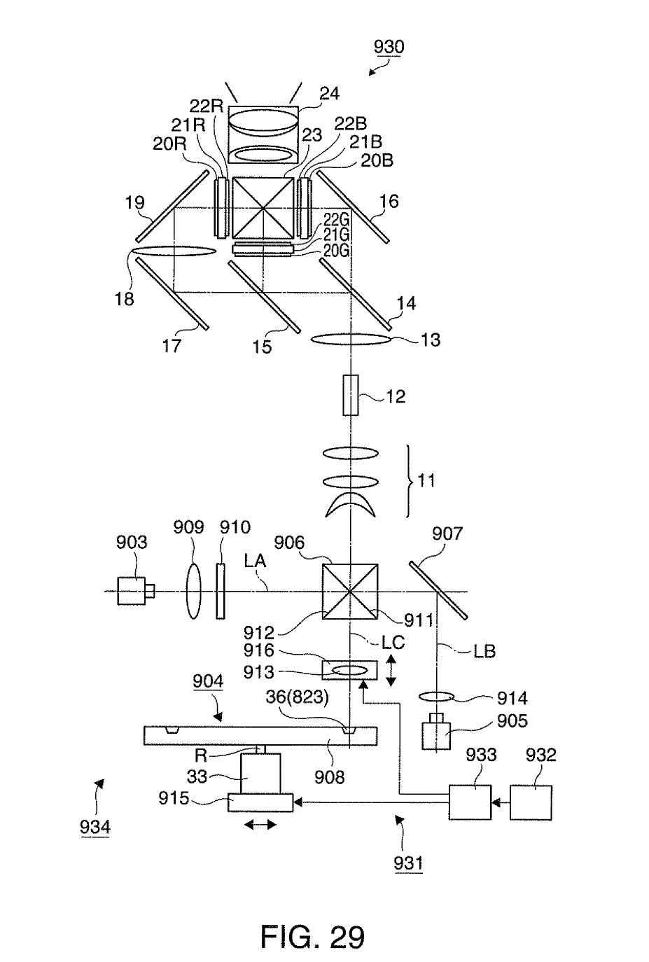

FIG. 29 is a schematic configuration diagram illustrating a projector 930 according to the tenth embodiment of the invention. The projector 930 according to the present embodiment is similar to the ninth embodiment in that a correction unit 931 is provided. However, the configuration of the correction unit 931 of the tenth embodiment is different from that of the ninth embodiment.

In FIG. 29, like reference numerals denote like elements as in FIG. 28 of the ninth embodiment, and detailed description thereof will not be repeated. Similarly, according to the present embodiment, the fluorescent light emission face 825b of the light-transmitting layer 825 corresponds to the incident face of the light-emitting element 824.

As shown in FIG. 29, the projector 930 according to the present embodiment includes the first actuator 915, the second actuator 914, a data storage unit 932, and a control unit 933 as the correction unit 931. In comparison with the projector 900 of the ninth embodiment shown in FIG. 28, a light source device 934 of the projector 930 according to the present embodiment does not include a mechanism which includes the infrared laser diode and the optical detector for detecting the focusing deviation or the tracking deviation of the excitation light. For this reason, in the projector 930 according to the present embodiment, a simple reflection mirror may be used instead of the dichroic mirror 907.

The positional deviation of the incident face of the light-emitting element 824 generated when the phosphor wheel 904 is rotated, that is, the focusing deviation or the tracking deviation of the excitation light is measured in advance when the light source device 934 is assembled. A relationship between the direction and the deviation of the focusing deviation and the rotational angle of the phosphor wheel 904 obtained through measurement, and a relationship between the deviation amount and the direction of the tracking deviation and the rotational angle of the phosphor wheel 904 obtained through measurement are stored in the data storage unit 932 as a mapping data.

As the projector 930 is actuated, the control unit 933 transmits, to the second actuator 916, a driving signal for shifting the pickup lens 913 in parallel with the optical axis LC based on the mapping data of the data storage unit 932. In addition, the control unit 933 transmits, to the first actuator 915, a driving signal for shifting the phosphor wheel 904 perpendicularly to the optical axis LC depending on the deviation amount and the direction of the tracking deviation based on the mapping data of the data storage unit 932. The second actuator 916 drives the pickup lens 913 in parallel with the optical axis LC such that the light condensed by the pickup lens 913 is best focused on the incident face of the light-emitting element 824 at all times. The first actuator 915 drives the phosphor wheel 904 perpendicularly to the optical axis LC such that the light condensed by the pickup lens 913, that is, the spot of the excitation light does not exceed the incident face of the light-emitting element 824 at all times.

Similar to the first to ninth embodiments described above, in the projector 930 according to the present embodiment, since the reflective portion is provided in the side face of the phosphor layer 36, the light propagating inside the phosphor layer 36 is easily emitted to the air from the emission face of the phosphor layer. As a result, it is possible to improve the optical use efficiency over the entire system of the projector. In addition, since the focusing deviation or the tracking deviation is reliably corrected by the correction unit 931, it is possible to suppress the fluctuation of the light emitted from the light source device 901. Since there is no mechanism for detecting the focusing deviation or the tracking deviation in comparison with the projector according to the ninth embodiment, it is possible to simplify the configuration of the correction unit 931.

The technical scope of the invention is not limited to the embodiments described above. Instead, various modifications may be added without departing from the spirit and scope of the invention.

For example, in the fourth embodiment, the fluorescent substrate 811 having the phosphor layer 36 provided in the trench formed in one surface of the substrate mainframe 812 in the same way as in the phosphor wheel 100 described in the first embodiment. However, the invention is not limited thereto. In the fourth embodiment, the fluorescent substrate in which the phosphor layer 36 is provided in the substrate mainframe 812 in the same way as in any aspect of the first to third modifications of the first embodiment and the third embodiment may be used.

Similarly, in the eighth embodiment, the fluorescent substrate 891 in which the phosphor layer 36 is provided in one surface of the substrate mainframe 892 in the same way as in the phosphor wheel 822 described in the fifth embodiment. However, the invention is not limited thereto. In the eighth embodiment, the fluorescent substrate in which the phosphor layer 36 is provided in the substrate mainframe 892 in the same way as in any aspect of the first to fifth modifications of the fifth embodiment and the seventh embodiment may be used.

Although the structural body 823 described in conjunction with the fifth embodiment is used as the structural body in the ninth and tenth embodiments, the invention is not limited thereto. In the ninth or tenth embodiment, any one of the structural bodies used in the first to eighth embodiments may be used. In addition, although the phosphor wheel 904 in which the structural body 823 is provided in the trench formed in one main surface of the wheel substrate 908 is used as the phosphor wheel in the ninth and tenth embodiments, the invention is not limited thereto. In the ninth or tenth embodiment, any one of the phosphor wheels described in the first to third embodiments and the fifth to seventh embodiments may be used.

In the ninth and tenth embodiments, a positional relationship between the spot of the excitation light and the phosphor layer 36 or the size of the spot of the excitation light is corrected such that the spot does not exceed the incident face of the light-emitting element 824. In other words, the incident face of the light-emitting element 824 is used as the target of the correction. However, the invention is not limited thereto. The interface between the phosphor layer 36 and the light-transmitting layer 825 may be used as the correction target, and a positional relationship between the spot of the excitation light and the phosphor layer 36 or the size of the spot of the excitation light may be corrected such that the spot does not exceed the corresponding interface. As a result, it is possible to further reduce fluctuation of the strength of the light emitted from the light source device.

As described in the first embodiment, in a case where the excitation light is incident on the phosphor layer 36 from the incident face 36a of the structural body 32, the incident face 36a on which the excitation light is incident is used as the correction target. It is possible to further reduce fluctuation of the strength of the light emitted from the light source device by correcting a relative positional relationship between the spot of the excitation light and the phosphor layer 36 or the size of the spot of the excitation light such that the deviation of the spot from the incident face 36a is suppressed.

As described in the third embodiment, in a case where the light-emitting element has no light-transmitting layer, and the excitation light is incident on the phosphor layer 36 from the emission face 36b of the structural body 32, the emission face 36b is used as the correction target.

In the configuration shown in the first modification of the first embodiment, the emission face 36b of the phosphor layer 36 is buried in the trench formed in one main surface of the wheel substrate 908. In this case, the correction target is set as follows. Specifically, in the cross section of the structural body 823 in the radial direction of the wheel substrate 908, the area having the end of wheel substrate 908 side of the first reflective portion 34a as one end and the end of the wheel substrate 908 side of the second reflective portion 34b as the other end is defined as the incident face of the light-emitting element. In addition, the corresponding incident face is used as the correction target.

Although the excitation light is condensed onto the incident face of the light-emitting element 824 in the ninth and tenth embodiments, the invention is not limited thereto. Regardless of the positional relationship in the optical axis direction of the excitation light between the condensing surface of the excitation light and the incident face of the light-emitting element 824, the correction target may be corrected such that the spot of the excitation light does not exceed the correction target as described above.

In addition, it is not necessary to condense the excitation light toward the phosphor layer 36. In a case where the collimated excitation light is used, it is possible to omit the second correction unit.

Although the positional deviation of the phosphor layer 36 is corrected such that the spot of the excitation light does not exceed the incident face of the light-emitting element 824 in order to efficiently use the excitation light in the ninth and tenth embodiments, the invention is not limited thereto. That is, at least one of the positional relationship between the phosphor layer and the spot of the excitation light and the size of the spot may be corrected such that fluctuation of the area where the spot of the excitation light and the correction target such as the incident face of the light-emitting element 824 are overlapped with each other is reduced. As a result, it is possible to reduce the fluctuation of the strength of the light emitted from the light source device.

The first actuator 915 may be provided in the pickup lens 913, and the pickup lens 913 may be shifted in parallel with the main surface of the wheel substrate 908. In addition, the second actuator 916 may be provided in the wheel motor 33, and the wheel substrate 908 may be shifted in parallel with the optical axis LC.

For example, in the embodiments described above, blue light or ultraviolet light is used as the excitation light, and yellow light is emitted as the fluorescent light. Instead of such a configuration, ultraviolet light may be used as the excitation light, and red light, green light, and blue light may be emitted as the fluorescent light so that three color light beams may be emitted in a time-multiplexed manner. Alternatively, blue light may be used as the excitation light, red light and green light may be emitted as the fluorescent light, and the blue light may be emitted without change, so that the three color light beams may be emitted in a time-multiplexed manner. In addition, the shape, the number, the arrangement, the material, and the like of each element of the light source device and the projector exemplified in the aforementioned embodiments may be changed as appropriate.

The entire disclosure of Japanese Patent Application No.: 2010-245032, filed on Nov. 1, 2010, 2010-245025, filed on Nov. 1, 2010 and 2011-196888, filed on Sep. 9, 2011 are expressly incorporated by reference herein.

1. A wavelength conversion element comprising:
a substrate;
a light-emitting element having at least a phosphor layer provided in one surface of the substrate; and
a first reflective portion provided in at least a first side face of the phosphor layer to change a propagation direction of a light propagating inside the phosphor layer such that an angle with respect to a normal line of an emission face, where a fluorescent light is emitted from the light-emitting element, is reduced.

2. The wavelength conversion element according to claim 1, wherein the substrate is rotatable around a rotation axis intersecting with the one surface of the substrate.

3. The wavelength conversion element according to claim 2, wherein the first side face is parallel to any one of a direction along a circle centered at the rotation axis and a direction intersecting with the circle.

4. The wavelength conversion element according to claim 3, further comprising a second reflective portion provided in a second side face of the phosphor layer opposite to the first side face to change a propagating direction of a light propagating inside the phosphor layer such that an angle with respect to the normal line of the emission face is reduced.

5. The wavelength conversion element according to claim 3, further comprising:
a third reflective portion provided in a third side face of the phosphor layer intersecting with the first side face to change a propagating direction of a light propagating inside the phosphor layer such that an angle with respect to the normal line of the emission face is reduced; and
a fourth reflective portion provided in a fourth side face of the phosphor layer opposite to the third side face to change a propagating direction of a light propagating inside the phosphor layer such that an angle with respect to the normal line of the emission face is reduced.

6. The wavelength conversion element according to claim 1, wherein the light-emitting element further includes a light-transmitting layer provided in a side of the phosphor layer opposite to the substrate.

7. The wavelength conversion element according to claim 6, wherein the phosphor layer has a binder in which a plurality of phosphor particles is distributed, and
a refractive index of the light-transmitting layer is equal to a refractive index of the binder.

8. The wavelength conversion element according to claim 1, wherein the phosphor layer is provided in a trench provided in the substrate.

9. The wavelength conversion element according to claim 1, further comprising a heat conduction member provided in a side of the first reflective portion opposite to the phosphor layer.

10. The wavelength conversion element according to claim 9, wherein the substrate is made of metal.

11. A light source device comprising:
an excitation light source unit for emitting an excitation light; and
a wavelength conversion element for emitting a fluorescent light by being irradiated with the excitation light according to claim 1.

12. The light source device according to claim 11, wherein, in a radial direction of a circle centered at a rotation axis intersecting with the one surface of the substrate, a size of a spot of the excitation light formed in the wavelength conversion element is equal to or smaller than a width of an incident face of the light-emitting element on which the excitation light is incident.

13. The light source device according to claim 11, further comprising:
a drive unit for driving the wavelength conversion element such that the spot is shifted temporally on the wavelength conversion element; and
a correction unit for correcting at least one of a positional relationship between the phosphor layer and the spot and a size of the spot when the drive unit drives the wavelength conversion element.

14. The light source device according to claim 13, wherein the wavelength conversion element is rotatable around a rotation axis intersecting with the one surface of the substrate, and
the phosphor layer is provided along a circle centered at the rotation axis on the one surface of the substrate.

15. The light source device according to claim 13, wherein the correction unit includes a first correction unit for correcting a positional deviation of the phosphor layer in a direction perpendicular to an optical axis direction of the excitation light.

16. The light source device according to claim 13, wherein the correction unit includes a second correction unit for correcting a size of the spot by correcting a positional deviation of the phosphor layer in an optical axis direction of the excitation light.

17. The light source device according to claim 13, further comprising a detection unit for detecting an amount of a positional deviation of the phosphor layer,
wherein the correction unit corrects the positional deviation based on a detection result of the detection unit.

18. The light source device according to claim 13, further comprising a data storage unit for storing data representing an amount of a positional deviation of the phosphor layer,
wherein the correction unit corrects the positional deviation based on the data stored in the data storage unit.

19. The light source device according to claim 11, wherein the substrate is rotatable around a rotation axis intersecting with the one surface of the substrate,
the first side face intersects with a circle centered at the rotation axis,
the wavelength conversion element further includes a second reflective portion for reflecting a light propagating inside the phosphor layer in parallel with the substrate to a direction opposite to the substrate, the second reflective portion being provided in a second side face of the phosphor layer opposite to the first side face, and
a pulse frequency F (Hz) is an integer multiple of a rotation number m (rps), where, F denotes a pulse frequency of the excitation light emitted from the excitation light source unit, and m denotes a rotation number of the wavelength conversion element.

20. A projector for modulating the light emitted from the light source device according to claim 11 in response to an image signal and projecting modulated light.
